(19) United States
(12) Patent Application Publication
(10) Pub. No.: US 2026/0055294 A1
(43) Pub. Date: Feb. 26, 2026

(54) METHOD FOR MANUFACTURING TRANSFER SHEET AND TRANSFER SHEET

(71) Applicant: FUJIFILM Corporation, Tokyo (JP)

(72) Inventors: Yuka MATSUMOTO, Kanagawa (JP); Masao IKOSHI, Kanagawa (JP); Misato SASADA, Kanagawa (JP); Hiromichi NUMAZAWA, Kanagawa (JP)

(73) Assignee: FUJIFILM Corporation, Tokyo (JP)

(21) Appl. No.: 19/303,337

(22) Filed: Aug. 18, 2025

(30) Foreign Application Priority Data
Aug. 20, 2024 (JP) 2024-139203
Aug. 15, 2025 (JP) 2025-135355

(51) Int. Cl. C09D 133/10; B32B 7/06; B32B 7/12; B32B 15/082

(52) U.S. Cl. CPC C09D 133/10; B32B 7/06; B32B 7/12; B32B 15/082

(57) ABSTRACT

Provide is a method for manufacturing a transfer sheet in which a transfer sheet having excellent blocking resistance and excellent friction resistance of a transferred material can be manufactured. Also provided is a transfer sheet having excellent blocking resistance and excellent friction resistance of a transferred material.

The method for manufacturing a transfer sheet includes: a step 1 of forming a decorative layer on a temporary support; a step 2 of applying a composition including a (meth)acrylate compound to the decorative layer to form a coating film; a step 3 of forming a hot melt adhesive layer on the coating film; and a step 4 of curing the coating film to form an image layer including a (meth)acrylate resin, in which an intensity ratio P₁ obtained from Expression (X1) is 0.005 to 0.300.

### CROSS-REFERENCE TO RELATED APPLICATIONS

The present application claims priority under 35 U.S.C. § 119 to Japanese Patent Application No. 2024-139203, filed on Aug. 20, 2024 and Japanese Patent Application No. 2025-135355, filed on Aug. 15, 2025. The above applications are hereby expressly incorporated by reference, in its entirety, into the present application.

### BACKGROUND OF THE INVENTION

### 1. Field of the Invention

The present invention relates to a method for manufacturing a transfer sheet and a transfer sheet.

### 2. Description of the Related Art

Recently, various investigations on a textile printing method on fabric have been conducted. In addition, a wide variety of designability is required for a printed material obtained by textile printing. For example, the printed material has high glossiness.

For example, JP1988-302087A (JP-S63-302087A) discloses a metallic thin film sheet that can be transferred through a pressure-sensitive operation irrespective of a plane or a curved surface, the metallic thin film having a layer configuration including a base film (1) where a release layer (la) having releasability is provided/a protective layer (2)/a metal deposition layer (3)/an adhesive layer (4)/an elastic resin layer (5)/a pressure-sensitive adhesive layer (6)/a peeling sheet (7) in this order, in which the elastic resin layer (5) is formed of a resin where an elongation at break in a tensile strength test of the sheet having a length of 25 mm is 2% to 300%.

### SUMMARY OF THE INVENTION

The present inventors conducted the method for manufacturing a transfer sheet described in JP1988-302087A (JP-S63-302087A), and found that, depending on the manufacturing method, in a case where a plurality of transfer sheets to be formed are laminated, the transfer sheets excessively adhere to each other such that chipping of an image layer may occur (blocking resistance is poor) during peeling of the transfer sheet and friction resistance of a transferred material may be poor.

Accordingly, an object of the present invention is to provide a method for manufacturing a transfer sheet in which a transfer sheet having excellent blocking resistance and excellent friction resistance of a transferred material can be manufactured.

In addition, another object of the present invention is to provide a transfer sheet having excellent blocking resistance and excellent friction resistance of a transferred material.

The present inventors found that the object can be achieved by the following configurations.
[1] A method for manufacturing a transfer sheet, the method comprising:
a step 1 of forming a decorative layer on a temporary support;
a step 2 of applying a composition including one or more kinds selected from the group consisting of an acrylate compound and a methacrylate compound to the decorative layer to form a coating film;
a step 3 of forming a hot melt adhesive layer on the coating film; and
a step 4 of curing the coating film to form an image layer including one or more kinds selected from the group consisting of an acrylate resin and a methacrylate resin, in which an intensity ratio P₁ obtained from Expression (X1) is 0.005 to 0.300,

$${P}_{1} = {Z}_{12} / {Z}_{11} \qquad Expression ( X1 )$$

in Expression (X1), P₁ represents the intensity ratio,
Z₁₁ represents a normalized carbon double bond peak intensity of the coating film obtained from Expression (X2), and
Z₁₂ represents a normalized carbon double bond peak intensity of a surface of the image layer on the hot melt adhesive layer side obtained from Expression (X3),

$${Z}_{11} = {Y}_{11} / {X}_{11} \qquad Expression ( X2 )$$

in Expression (X2), X₁₁ represents a peak intensity derived from C═O of an ester group obtained by infrared absorption spectroscopy of the coating film,
Y₁₁ represents a peak intensity derived from a carbon double bond C═C obtained by the infrared absorption spectroscopy of the coating film, and
Z₁₁ represents the normalized carbon double bond peak intensity,

$${Z}_{12} = {Y}_{12} / {X}_{12} , \qquad Expression ( X3 )$$

in Expression (X3), X₁₂ represents a peak intensity derived from C═O of an ester group obtained by infrared absorption spectroscopy of the surface of the image layer on the hot melt adhesive layer side,
Y₁₂ represents a peak intensity derived from a carbon double bond C═C obtained by the infrared absorption spectroscopy of the surface of the image layer on the hot melt adhesive layer side, and
Z₁₂ represents the normalized carbon double bond peak intensity.
[2] The method for manufacturing a transfer sheet according to [1],
in which in the step 2, the coating film is formed on at least a part of the decorative layer, and
the step 3 is a step of spraying a powdered hot melt adhesive from the coating film side, removing the hot melt adhesive from a portion other than the coating film, and forming the hot melt adhesive layer on the coating film.
[3] The method for manufacturing a transfer sheet according to [1] or [2],
in which the composition includes one or more kinds selected from the group consisting of a monofunctional acrylate compound, a monofunctional methacrylate compound, a bifunctional acrylate compound, and a bifunctional methacrylate compound, and
a total content of the monofunctional acrylate compound, the monofunctional methacrylate compound, the bifunctional acrylate compound, and the bifunctional methacrylate compound with respect to a total solid content of the composition is 50% by mass or more.
[4] The method for manufacturing a transfer sheet according to any one of [1] to [3],
in which a weight-average molecular weight of the acrylate resin and the methacrylate resin in the image layer is 200,000 or more.
[5] The method for manufacturing a transfer sheet according to any one of [1] to [4],
in which the composition includes a compound represented by Formula (1) described below.
[6] The method for manufacturing a transfer sheet according to [5],
in which both of R₃ and R₄ each independently represent a linear or branched alkylene group.
[7] The method for manufacturing a transfer sheet according to any one of [1] to [6],
in which the decorative layer is a metal layer or a cholesteric liquid crystal layer, and the metal layer is a metal foil or a metal deposition layer.
[8] The method for manufacturing a transfer sheet according to any one of [1] to [7],
in which in a plan view of the transfer sheet, the hot melt adhesive layer is disposed on only the image layer, and a ratio of an area of the hot melt adhesive layer to an area of the image layer is 60% to 100%.
[9]A transfer sheet manufactured using the manufacturing method according to [1],
the transfer sheet comprising, in the following order:
a temporary support;
a decorative layer;
an image layer; and
a hot melt adhesive layer,
in which the image layer includes one or more kinds selected from the group consisting of an acrylate resin and a methacrylate resin,
an intensity ratio P₂ obtained from Expression (Y1) is 1.25 to 50.0,

$${P}_{2} = {Z}_{22} / {Z}_{21} , \qquad Expression ( Y 1 )$$

in Expression (Y1), P₂ represents the intensity ratio,
Z₂₁ represents a normalized carbon double bond peak intensity of a surface of the image layer on the decorative layer side obtained from Expression (Y2), and
Z₂₂ represents a normalized carbon double bond peak intensity of a surface of the image layer on the hot melt adhesive layer side obtained from Expression (Y3),

$${Z}_{21} = {Y}_{21} / {X}_{21} , \qquad Expression ( Y 2 )$$

in Expression (Y2), X₂₁ represents a peak intensity derived from C═O of an ester group obtained by infrared absorption spectroscopy of the surface of the image layer on the decorative layer side,
Y₂₁ represents a peak intensity derived from a carbon double bond C═C obtained by the infrared absorption spectroscopy of the surface of the image layer on the decorative layer side, and
Z₂₁ represents the normalized carbon double bond peak intensity,

$${Z}_{22} = {Y}_{22} / {X}_{22} , \qquad Expression ( Y 3 )$$

in Expression (Y3), X₂₂ represents a peak intensity derived from C═O of an ester group obtained by infrared absorption spectroscopy of the surface of the image layer on the hot melt adhesive layer side,
Y₂₂ represents a peak intensity derived from a carbon double bond C═C obtained by the infrared absorption spectroscopy of the surface of the image layer on the hot melt adhesive layer side, and
Z₂₂ represents the normalized carbon double bond peak intensity.
[10] The transfer sheet according to [9],
in which the image layer is a cured layer derived from a composition including one or more kinds selected from the group consisting of an acrylate compound and a methacrylate compound,
the composition includes one or more kinds selected from the group consisting of a monofunctional acrylate compound, a monofunctional methacrylate compound, a bifunctional acrylate compound, and a bifunctional methacrylate compound, and
a total content of the monofunctional acrylate compound, the monofunctional methacrylate compound, the bifunctional acrylate compound, and the bifunctional methacrylate compound with respect to a total solid content of the composition is 50% by mass or more.
[11] The transfer sheet according to [9] or [10],
in which a weight-average molecular weight of the acrylate resin and the methacrylate resin in the image layer is 200,000 or more.
[12] The transfer sheet according to any one of [9] to [11],
in which the composition includes a compound represented by Formula (1) described below.
[13] The transfer sheet according to [12],
in which both of R₃ and R₄ each independently represent a linear or branched alkylene group.
[14] The transfer sheet according to any one of claims [9] to [13],
in which the decorative layer is a metal layer or a cholesteric liquid crystal layer, and
the metal layer is a metal foil or a metal deposition layer.
[15] The transfer sheet according to any one of [9] to [14],
in which in a plan view of the transfer sheet, the hot melt adhesive layer is disposed on only the image layer, and a ratio of an area of the hot melt adhesive layer to an area of the image layer is 60% to 100%.

According to the present invention, it is possible to provide a method for manufacturing a transfer sheet in which a transfer sheet having excellent blocking resistance and excellent friction resistance of a transferred material can be manufactured.

According to the present invention, it is also possible to provide a transfer sheet having excellent blocking resistance and excellent friction resistance of a transferred material.

### BRIEF DESCRIPTION OF THE DRAWINGS

FIG. 1 is a schematic diagram showing an example of an embodiment of a transfer sheet obtained using a manufacturing method according to the present invention.

### DESCRIPTION OF THE PREFERRED EMBODIMENTS

Hereinafter, the details of the present invention will be described.

The following description regarding configuration requirements has been made based on a representative embodiment of the present invention. However, the present invention is not limited to the embodiment.

In the present specification, numerical ranges represented by “to” include numerical values before and after “to” as lower limit values and upper limit values.

In addition, regarding numerical ranges that are described stepwise in the present specification, an upper limit value or a lower limit value described in a numerical value may be replaced with an upper limit value or a lower limit value of another stepwise numerical range. In addition, in the numerical range described in the present specification, an upper limit value and a lower limit value described in a certain numerical range may be replaced with values shown in Examples.

In addition, the term “step” in the present specification indicates not only an independent step but also a step that cannot be clearly distinguished from other steps as long as the intended purpose of the step is achieved.

In the present specification, a temperature condition may be set to 25° C. unless otherwise specified. For example, unless otherwise specified, a temperature at which each of the above-described steps is performed may be 25° C.

In the present specification, unless otherwise specified, a molecular weight in a case where a molecular weight distribution is present is a weight-average molecular weight.

In addition, in the present specification, the weight-average molecular weight is a value measured by gel permeation chromatography (GPC).

The GPC was performed using HLC-8020GPC (manufactured by TOSOH CORPORATION), three columns of TSKgel (registered trademark), and Super Multipore HZ-H (manufactured by TOSOH CORPORATION, 4.6 mm ID×15 cm), and tetrahydrofuran (THF) as an eluent.

In addition, the GPC is performed using a differential refractive index (RI) detector under conditions of a sample concentration of 0.45% by mass, a flow rate of 0.35 ml/min, a sample injection amount of 10 μl, and a measurement temperature of 40° C.

The calibration curve is prepared using eight samples of “F-40”, “F-20”, “F-4”, “F-1”, “A-5000”, “A-2500”, “A-1000”, and “n-propylbenzene” which are “Standard Samples TSK standard, polystyrene” (manufactured by TOSOH CORPORATION).

In the present specification, “(meth)acrylate compound” is a generic name for compounds selected from the group consisting of an acrylate compound and a methacrylate compound, “(meth)acrylate resin” is a generic name for compounds selected from the group consisting of an acrylate resin and a methacrylate resin, and “(meth)acryloyl” is a concept including both of acryloyl and methacryloyl.

“Solid content” of a composition indicates a component forming a composition layer (for example, a coating film obtained in a step 2 described below) formed of the composition, and in a case where the composition contains a solvent (for example, an organic solvent or water), the solid content indicates all the components excluding the solvent. In addition, in a case where the components are components forming a composition layer, even a liquid component is also considered to be included in the solid content.

In the present specification, unless otherwise specified, a thickness of a layer (film thickness) is an average thickness measured using a scanning electron microscope (SEM) for a thickness of 0.5 μm or more, and is an average thickness measured using a transmission electron microscope (TEM) for a thickness of less than 0.5 μm. The above-described average thickness is an average thickness obtained by forming a section to be measured using an ultramicrotome, measuring thicknesses of any five points, and obtaining an arithmetic mean value thereof.

### Method for Manufacturing Transfer Sheet

A method for manufacturing a transfer sheet according to an embodiment of the present invention (hereinafter, also referred to as “manufacturing method according to the embodiment of the present invention” includes:
a step 1 of forming a decorative layer on a temporary support;
a step 2 of applying a composition including one or more kinds selected from the group consisting of an acrylate compound and a methacrylate compound to the decorative layer to form a coating film;
a step 3 of forming a hot melt adhesive layer on the coating film; and
a step 4 of curing the coating film to form an image layer including one or more kinds selected from the group consisting of an acrylate resin and a methacrylate resin,
in which an intensity ratio P₁ obtained from Expression (X1) is 0.005 to 0.300.

$${P}_{1} = {Z}_{12} / {Z}_{11} \qquad Expression ( X1 )$$

In Expression (X1), P₁ represents the intensity ratio. Z₁₁ represents a normalized carbon double bond peak intensity of the coating film obtained from Expression (X2). Z₁₂ represents a normalized carbon double bond peak intensity of a surface of the image layer on the hot melt adhesive layer side obtained from Expression (X3).

$${Z}_{11} = {Y}_{11} / {X}_{11} \qquad Expression ( X2 )$$

In Expression (X2), X₁₁ represents a peak intensity derived from C═O of an ester group obtained by infrared absorption spectroscopy of the coating film. Y₁₁ represents a peak intensity derived from a carbon double bond C═C obtained by the infrared absorption spectroscopy of the coating film. Z₁₁ represents the normalized carbon double bond peak intensity.

$${Z}_{12} = {Y}_{12} / {X}_{12} , \qquad Expression ( X3 )$$

In Expression (X3), X₁₂ represents a peak intensity derived from C═O of an ester group obtained by infrared absorption spectroscopy of the surface of the image layer on the hot melt adhesive layer side. Y₁₂ represents a peak intensity derived from a carbon double bond C═C obtained by the infrared absorption spectroscopy of the surface of the image layer on the hot melt adhesive layer side. Z₁₂ represents the normalized carbon double bond peak intensity.

The transfer sheet obtained using the manufacturing method according to the embodiment of the present invention has excellent blocking resistance and excellent friction resistance of a transferred material.

Examples of main feature points of the manufacturing method according to the embodiment of the present invention include: a point that the hot melt adhesive layer is formed on the coating film without curing the coating film formed on the decorative layer, and the image layer is formed by curing the coating film after the formation of the hot melt adhesive layer; and a point that a residual carbon double bond in the surface of the image layer on the hot melt adhesive layer side is adjusted to be in a predetermined range (the intensity ratio P₁ obtained from Expression (X1) is 0.005 to 0.300).

In the manufacturing method according to the embodiment of the present invention having the above-described feature points, the intensity ratio P₁ of the surface of the image layer on the hot melt adhesive layer side formed in the step 4 that is obtained from Expression (X1) is 0.005 or more. As a result, the obtained transfer sheet exhibits flexibility required for transfer during transfer, and is likely to be transferred along unevenness of a transfer target material. Further, by curing the image layer in the transferred material by light irradiation or the like to polymerize the residual carbon double bond, the image layer in the transferred material is cured, and thus the transferred material can be more strongly adhered. As a result, it is presumed that the transferred material has excellent friction resistance. Typically, in a case where a transfer layer such as a metal foil or a metal deposition layer having excellent smoothness that includes the decorative layer (the transfer layer refers to a layer that is formed on the temporary support and is to be transferred to a transfer target material; the transfer layer includes the decorative layer, the image layer, and the hot melt adhesive layer) is desired to be transferred to an uneven substrate such as fabric, the transfer layer is not likely to follow the uneven substrate. Therefore, a physical anchor effect does not act between the transfer layer and the uneven substrate, and the obtained transferred material tends to have poor friction resistance. On the other hand, in a case where the transfer sheet obtained using the manufacturing method according to the embodiment of the present invention includes the decorative layer such as a metal foil or a metal deposition layer due to the above-described action mechanism, the transfer sheet is likely to follow unevenness of a transfer target material, and a physical anchor effect is likely to act between the transfer layer and the uneven substrate. In addition, by curing the image layer in the transferred material by light irradiation or the like to polymerize the residual carbon double bond, the transferred material and the uneven substrate can be more strongly adhered to each other.

In addition, the intensity ratio P₁ of the surface of the image layer on the hot melt adhesive layer side formed in the step 4 that is obtained from Expression (X1) is 0.300 or less. As a result, it is presumed that the image layer is not excessively flexible, and the obtained transfer sheet has excellent blocking resistance.

Further, the image layer is formed by curing the coating film after the formation of the hot melt adhesive layer, and thus adhesiveness between the hot melt adhesive layer and the image layer is excellent. This point is also considered one factor for excellent friction resistance of a transferred material.

Hereinafter, in the transfer sheet obtained using the manufacturing method according to the embodiment of the present invention, blocking resistance and/or higher friction resistance of a transferred material being further improved will also be referred to as “the effect of the present invention being further improved”.

### Configuration of Transfer Sheet

Hereinafter, first, the configuration of the transfer sheet that can be obtained using the manufacturing method according to the embodiment of the present invention will be described.

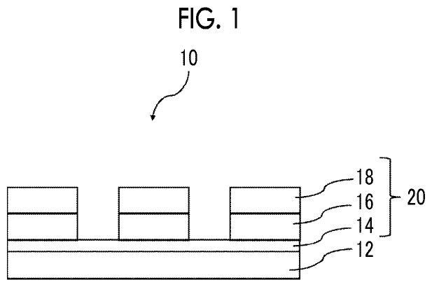

FIG. 1 is a schematic cross sectional view showing an example of the embodiment of the transfer sheet.

A transfer sheet 10 shown in FIG. 1 has a configuration where a temporary support 12 and a transfer layer 20 including a decorative layer 14, an image layer 16, and a hot melt adhesive layer 18 on the temporary support 12 are laminated in this order.

The transfer sheet 10 shown in FIG. 1 has the form where the decorative layer 14 is disposed on the entire surface of a main surface of the temporary support 12. However, the decorative layer 14 may be disposed on a part of the main surface of the temporary support 12.

In addition, the transfer sheet 10 shown in FIG. 1 has the form where the image layer 16 is partially disposed on the decorative layer 14. However, the image layer 16 may be disposed on the entire surface of the decorative layer 14.

In addition, the transfer sheet 10 shown in FIG. 1 has the form where the hot melt adhesive layer 18 is disposed on the entire surface of the image layer 16. However, the hot melt adhesive layer 18 may be disposed on a part of the image layer 16, or may be disposed to cover the image layer 16.

Hereinafter, each of the steps in the manufacturing method according to the embodiment of the present invention will be described.

### Step 1

The step 1 is a step of forming the decorative layer on the temporary support.

### Temporary Support

The temporary support is a member that supports the transfer layer such as the image layer disposed on the temporary support. As described below, in a case where the transfer sheet is used, the temporary support is peeled off from the transfer sheet after transferring the transfer layer to a transfer target material.

Examples of the temporary support include paper, leather, fabric, and a resin film. Among these, a resin film is more preferable.

Examples of the resin that is the material of the resin film include cellulose diacetate, cellulose triacetate, cellulose propionate, cellulose butyrate, cellulose acetate butyrate, cellulose nitrate, an acrylic resin, a chlorinated polyolefin resin, a polyether sulfone resin, polyester (for example, polyethylene terephthalate (PET) or polyethylene naphthalate), nylon, polyethylene, polystyrene, polypropylene, a polycycloolefin resin, polyvinyl chloride, polyamide, polyimide, polycarbonate, polyethersulfone, polyetheretherketone, polyvinyl acetal, and polyurethane.

The resin film may include one resin or a mixture of two or more resins.

The temporary support may include the resin film and another layer such as an easy adhesion layer, an antistatic layer, or an antifouling layer that is disposed on the resin film.

In addition, in order to improve adhesiveness between the temporary support and the transfer layer formed on the temporary support, a surface of the temporary support in contact with the transfer layer may be reformed by ultraviolet (UV) irradiation, corona discharge, plasma, or the like.

In addition, the temporary support may include various additives such as an ultraviolet (UV) absorber, matte agent fine particles, a plasticizer, a deterioration inhibitor, or a release agent.

A thickness of the temporary support is not particularly limited, and is, for example, 1 m to 10 mm.

From the viewpoint of thinning and handleability, the thickness of the temporary support is preferably 10 to 200 μm and more preferably 20 to 200 μm.

### Decorative Layer

It is preferable that the decorative layer is a layer for further improving the designability of the image layer and is a layer having excellent glossiness.

As the decorative layer, a layer (reflective layer) such as a metal layer, a cholesteric liquid crystal layer, or a dielectric multi-layer film having a function of reflecting at least a part of incident light is preferable, a metal layer or a cholesteric liquid crystal layer is preferable, and a metal foil or a metal deposition layer is more preferable.

### Metal Layer

Examples of the metal layer include a metal thin film that is formed with a method such as foil transfer, vapor deposition, or sputtering using a metal such as aluminum, indium, brass, chromium, gold, silver, or copper, and a coating film that is formed of a coating composition including a metal pigment formed of a flaky foil piece such as an aluminum flake, an indium flake, or brass. In particular, the metal layer is preferably a metal foil or a metal deposition layer.

### Cholesteric Liquid Crystal Layer

The cholesteric liquid crystal layer indicates a layer with a cholesteric liquid crystalline phase fixed.

The cholesteric liquid crystal layer only needs to be a layer in which the alignment of the liquid crystal compound as a cholesteric liquid crystalline phase is immobilized. It is preferable that the cholesteric liquid crystal layer is a layer obtained by aligning a polymerizable liquid crystal compound to enter an alignment state of a cholesteric liquid crystalline phase and polymerizing and curing the polymerizable liquid crystal compound by ultraviolet irradiation, or heating, or the like. It is preferable that the cholesteric liquid crystal layer is a layer that has no fluidity and is changed into a state where the alignment state does not change due to an external field or an external force. The cholesteric liquid crystal layer is not particularly limited as long as the optical characteristics of the cholesteric liquid crystalline phase are maintained, and the liquid crystal compound in the layer does not necessarily exhibit liquid crystallinity. For example, the molecular weight of the polymerizable liquid crystal compound may be increased by a curing reaction such that the liquid crystallinity thereof is lost.

It is known that the cholesteric liquid crystalline phase exhibits selective reflectivity at a specific wavelength.

A central wavelength of selective reflection (selective reflection center wavelength) λ of a general cholesteric liquid crystalline phase depends on a helical pitch P in the cholesteric liquid crystalline phase and satisfies a relationship of λ=n×P with an average refractive index n of the cholesteric liquid crystalline phase. Therefore, the selective reflection center wavelength can be adjusted by adjusting the helical pitch.

The selective reflection center wavelength of the cholesteric liquid crystalline phase increases as the helical pitch increases.

The helical pitch refers to one pitch (period of helix) of the helical structure of the cholesteric liquid crystalline phase, in other words, one helical turn. That is, the helical pitch refers to the length in a helical axis direction in which a director (in the case of a rod-shaped liquid crystal, a major axis direction) of the liquid crystal compound forming the cholesteric liquid crystalline phase rotates by 360°.

The helical pitch of the cholesteric liquid crystalline phase depends on the kind of the chiral agent used together with the liquid crystal compound and the concentration of the chiral agent added during the formation of the cholesteric liquid crystal layer. Therefore, a desired helical pitch can be obtained by adjusting these conditions.

The details of the adjustment of the pitch can be found in “Fuji Film Research & Development” No. 50 (2005), pp. 60 to 63. As a method of measuring a sense of helix and a helical pitch, a method described in “Introduction to Experimental Liquid Crystal Chemistry”, (the Japanese Liquid Crystal Society, 2007, Sigma Publishing Co., Ltd.), p. 46, and “Liquid Crystal Handbook” (the Editing Committee of Liquid Crystal Handbook, Maruzen Publishing Co., Ltd.), p. 196 can be used.

In addition, the cholesteric liquid crystalline phase exhibits selective reflectivity with respect to left or right circularly polarized light at a specific wavelength. Whether or not the reflected light is right circularly polarized light or left circularly polarized light is determined depending on a helical twisted direction (sense) of the cholesteric liquid crystalline phase. Regarding the selective reflection of the circularly polarized light by the cholesteric liquid crystalline phase, in a case where the helical twisted direction of the cholesteric liquid crystal layer is right, right circularly polarized light is reflected, and in a case where the helical twisted direction of the cholesteric liquid crystal layer is left, left circularly polarized light is reflected.

A direction of rotation of the cholesteric liquid crystalline phase can be adjusted by adjusting the kind of the liquid crystal compound that forms the cholesteric liquid crystal layer and/or the kind of the chiral agent to be added.

The color of the cholesteric liquid crystal layer and the degree of a change in the color of the cholesteric liquid crystal layer depending on an observation angle can be appropriately adjusted by a length in a thickness direction of the helical pitch in the cholesteric liquid crystal layer, a refractive index of the cholesteric liquid crystal layer, a thickness of the cholesteric liquid crystal layer, and the like.

The decorative layer may include a plurality of cholesteric liquid crystal layers. In a case where the transfer sheet includes a plurality of cholesteric liquid crystal layers, helical pitches of the cholesteric liquid crystal layers may be different from each other. In addition, the cholesteric liquid crystal layer may have a configuration where the helical pitch gradationally changes.

A method of forming the cholesteric liquid crystal layer is not particularly limited, and a well-known method can be used. For example, the cholesteric liquid crystal layer can be formed using a liquid crystal composition including a liquid crystal compound and a chiral agent.

As the cholesteric liquid crystal layer as the decorative layer, for example, cholesteric liquid crystal layers described in WO2020/203318A and JP2024-063719A can be found.

The decorative layer may have any one of a monolayer configuration or a multilayer configuration.

A thickness of the decorative layer is not particularly limited, and the lower limit value is, for example, 0.001 μm or more. The lower limit value is preferably 0.01 μm or more, and more preferably 0.1 μm or more. For example, the upper limit value is, for example, 300 μm or less and preferably 100 μm or less.

### Method of Forming Decorative Layer

As a method of forming the decorative layer, various well-known methods can be applied depending on the kind of the decorative layer to be formed.

### Step 2

The step 2 is a step of applying a composition (hereinafter, also referred to as “ink”) including a (meth)acrylate compound to the decorative layer to form a coating film.

Hereinafter, first, the composition used in the step 2 will be described, and then the procedure of the step 2 will be described.

### Composition

The composition includes one or more kinds of (meth)acrylate compounds selected from the group consisting of an acrylate compound and a methacrylate compound.

The composition is preferably an ink composition including a (meth)acrylate compound, a photopolymerization initiator, and an organic solvent, and more preferably a composition including a (meth)acrylate compound, a photopolymerization initiator, an organic solvent, and a colorant. Hereinafter, the components that may be included in the composition will be described in detail.

### (Meth)Acrylate Compound

The composition includes a (meth)acrylate compound.

In the (meth)acrylate compound, the number of (meth)acryloyloxy groups is not particularly limited, is, for example, 1 to 6, and from the viewpoint of further improving bending properties and alcohol resistance of the image layer, is preferably 2 to 6, more preferably 2 to 4, and still more preferably 2 and 3.

The (meth)acrylate compound may be any one of a monomer, an oligomer, or a mixture thereof.

Examples of a monofunctional (meth)acrylate compound (compound selected from the group consisting of a monofunctional acrylate compound and a monofunctional methacrylate compound) include phenoxyethyl acrylate (PEA), cyclic TMP formal acrylate (CTFA), isobornyl acrylate (IBOA), tetrahydrofurfuryl acrylate (THFA), 2-(2-ethoxyethoxy)ethyl acrylate, octaldecyl acrylate (ODA), tridecyl acrylate (TDA), isodecyl acrylate (IDA) and lauryl acrylate. Among these PEA is preferable.

Examples of a polyfunctional (meth)acrylate compound (compound selected from the group consisting of a polyfunctional acrylate compound and a polyfunctional methacrylate compound) include hexanediol diacrylate, trimethylolpropane triacrylate, pentaerythritol triacrylate, polyethylene glycol diacrylate (for example, tetraethylene glycol diacrylate), dipropylene glycol diacrylate, tri(propylene glycol) triacrylate, neopentyl glycol diacrylate, bis(pentaerythritol) hexaacrylate, and an acrylate ester of an ethoxylated or propoxylated glycol and a polyol (for example, propoxylated neopentyl glycol diacrylate, ethoxylated trimethylolpropane triacrylate, or a mixture thereof).

In addition, specific examples of the polyfunctional (meth)acrylate compound also include hexanediol dimethacrylate, trimethylolpropane trimethacrylate, triethylene glycol dimethacrylate, diethylene glycol dimethacrylate, ethylene glycol dimethacrylate, and 1,4-butanediol dimethacrylate.

The (meth)acrylate compound is preferably an oligomer from the viewpoint of further improving adhesiveness and bending properties of an image.

Examples of the (meth)acrylate compound include urethane (meth)acrylate, bisphenol A epoxy (meth)acrylate, and epoxy novolak (meth)acrylate. Among these, urethane (meth)acrylate is preferable.

Examples of the urethane (meth)acrylate include polyether-based urethane (meth)acrylate having a polyether skeleton, polyester-based urethane (meth)acrylate having a polyester skeleton, and polycarbonate-based (meth)urethane acrylate oligomer having a polycarbonate skeleton. Among these, polyether-based urethane (meth)acrylate is preferable.

In addition, as the urethane (meth)acrylate, an aliphatic (meth)urethane acrylate is preferable.

As the urethane (meth)acrylate, from the viewpoint of further improving the effect of the present invention, a polyether-based urethane (meth)acrylate is preferable, and a compound represented by Formula (1) is more preferable.

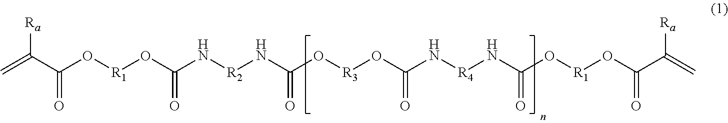

In Formula (1), Rₐ represents a hydrogen atom or a methyl group.
R₁ to R₄ each independently represent a divalent linking group. Examples of the divalent linking group represented by R₁ to R₄ include a hydrocarbon group where at least one —CH₂— group is substituted with —CO— and —O—.

Examples of the hydrocarbon group where at least one —CH₂— group is substituted with —CO— and —O— include an alkylene group or arylene group where at least one —CH₂— group is substituted with —CO— and —O—. From the viewpoint of further improving the effect of the present invention, an alkylene group (for example, a hexamethylene group) is preferable.

The alkylene group may be linear, branched, or cyclic. From the viewpoint of easily further improving the effect of the present invention, the alkylene group is preferably linear or branched. The number of carbon atoms in the alkylene group is preferably 2 to 10 and more preferably 4 to 8. Examples of the arylene group include a phenylene group.

The hydrocarbon group may further have a substituent.

n represents an integer of 1 to 10000, preferably 5 to 2000, and 10 to 200.

In Formula (1), at least one of R₃ or R₄ represents an alkylene group (preferably a linear or branched alkylene group), and it is preferable that both of R₃ and R₄ each independently represent an alkylene group (preferably a linear or branched alkylene group).

From the viewpoints of suitability of a viscosity of the composition and jetting stability in a case where the composition is applied to an ink jet, a weight-average molecular weight (Mw) of the (meth)acrylate compound is preferably 1000 to 30000, more preferably 1500 to 15000, still more preferably 2000 to 10000, and still more preferably 2000 to 7000.

From the viewpoints of suitability of a viscosity of the composition and jetting stability in a case where the composition is applied to an ink jet, a number-average molecular weight (Mn) of the (meth)acrylate compound is preferably 1000 to 30000, more preferably 1500 to 15000, still more preferably 2000 to 10000, and still more preferably 2000 to 7000.

Examples of a commercially available product of the (meth)acrylate compound include oligomers such as CN996 (bifunctional oligomer, urethane acrylate, weight-average molecular weight (Mw)=2,850) manufactured by Arkema Co., Inc.; UA-122P (bifunctional oligomer, urethane acrylate, Mw=1100) manufactured by SHIN-NAKAMURA CHEMICAL CO, LTD.; and SHIKOH (registered trademark) UV-6630B (bifunctional oligomer, urethane acrylate, Mw=3000), SHIKOH (registered trademark) UV-3310B (bifunctional oligomer, urethane acrylate, Mw=5000), and SHIKOH (registered trademark) UV-7630B (hexafunctional oligomer, urethane acrylate, Mw=2,200) manufactured by NIHON GOSEI KAKO Co., Ltd.

From the viewpoints of further improving bending properties and alcohol resistance of an image and adhesiveness of the image layer, it is preferable that the composition includes a (meth)acrylate compound that is an oligomer. In a case where the composition includes a (meth)acrylate compound that is an oligomer, the content of the (meth)acrylate compound that is the oligomer with respect to the total solid content of the composition is preferably 50% by mass or more and more preferably 60% by mass or more. The upper limit is preferably 95% by mass or less, and more preferably 90% by mass or less.

In addition, from the viewpoint of further improving texture of a transferred material obtained by transferring the transfer sheet, the total content of the monofunctional (meth)acrylate compound and the bifunctional (meth)acrylate compound (compound selected from the group consisting of a bifunctional acrylate compound and a bifunctional methacrylate compound) with respect to the total solid content of the composition is preferably 35% by mass or more, more preferably 40% by mass or more, and still more preferably 50% by mass or more. The upper limit is preferably 95% by mass or less, and more preferably 90% by mass or less.

From the viewpoints of preventing the network structure of the image layer from being excessively dense and further improving bending properties of an image and adhesiveness of an image, it is preferable that the composition includes one or more kinds of monofunctional (meth)acrylate compounds and one or more kinds of bifunctional (meth)acrylate compounds, and the total content of the monofunctional (meth)acrylate compounds and the bifunctional (meth)acrylate compounds with respect to the total mass of the (meth)acrylate compounds is preferably 50% by mass or more.

The content of a (meth)acrylate compound having a weight-average molecular weight of less than 1000 in the composition with respect to the total mass of the (meth)acrylate compounds is preferably 40% by mass or less, more preferably 30% by mass or less, still more preferably 20% by mass or less, still more preferably 10% by mass or less, and still more preferably 5% by mass or less.

Polymerizable Compound Other than (Meth)Acrylate Compound

The composition may include a polymerizable compound other than a (meth)acrylate compound (hereinafter, also referred to as “other polymerizable compound”).

Examples of the other polymerizable compounds include: vinyl ether monomers such as triethylene glycol divinyl ether, diethylene glycol divinyl ether, 1,4-cyclohexanedimethanol divinyl ether, or ethylene glycol monovinyl ether; N-vinylamides such as N-vinylcaprolactam (NVC) or N-vinylpyrrolidone (NVP); and N-(meth)acryloylamines such as N-acryloylmorpholine (ACMO).

The content of the (meth)acrylate compound in the composition with respect to the total mass of the polymerizable compound is preferably 80% to 100% by mass, more preferably 90% to 100% by mass, and still more preferably 95% to 100% by mass.

The content of the polymerizable compound in the composition with respect to the total solid content of the composition is preferably 50% to 95% by mass, more preferably 50% to 90% by mass, and still more preferably 60% to 90% by mass.

The content of the (meth)acrylate compound in the composition with respect to the total solid content of the composition is preferably 50% to 95% by mass, more preferably 50% to 90% by mass, and still more preferably 60% to 90% by mass.

### Colorant

It is preferable that the composition includes a colorant.

The colorant is not particularly limited, and may be any of a pigment or a dye and is preferably a pigment from the viewpoint of light fastness.

The pigment is not particularly limited, and can be appropriately selected depending on the purpose. It is preferable that the pigment is dispersed in a liquid medium of the composition.

The pigment may include any one of an organic pigment or an inorganic pigment, or may include an organic pigment and an inorganic pigment in combination.

Examples of the organic pigment include polycyclic pigments such as azo lakes, azo pigments, phthalocyanine pigments, perylene pigments, perinone pigments, anthraquinone pigments, quinacridone pigments, dioxazine pigments, diketopyrrolopyrrole pigments, thioindigo pigments, isoindolinone pigments, or quinophthalone pigments, dye lakes such as basic dye lakes and acidic dye lakes, nitro pigments, nitroso pigments, aniline black, and daylight fluorescent pigments.

Examples of the inorganic pigment include titanium oxide, iron oxide, calcium carbonate, barium sulfate, aluminum hydroxide, barium yellow, cadmium red, chrome yellow, and carbon black.

As the colorant, for example, an organic pigment or an inorganic pigment having the following number described in the color index can be used.

Examples of blue or cyan pigments include Pigment Blue 1, 15, 15:1, 15:2, 15:3, 15:4, 15:6, 16, 17-1, 22, 27, 28, 29, 36, and 60. Examples of green pigments include Pigment Green 7, 26, 36, and 50. Examples of red or magenta pigments include Pigment Red 3, 5, 9, 19, 22, 31, 38, 42, 43, 48:1, 48:2, 48:3, 48:4, 48:5, 49:1, 53:1, 57:1, 57:2, 58:4, 63:1, 81, 81:1, 81:2, 81:3, 81:4, 88, 104, 108, 112, 122, 123, 144, 146, 149, 166, 168, 169, 170, 177, 178, 179, 184, 185, 208, 216, 226, and 257, and Pigment Violet 3, 19, 23, 29, 30, 37, 50, and 88, and Pigment Orange 13, 16, 20, and 36. Examples of yellow pigments include Pigment Yellow 1, 3, 12, 13, 14, 17, 34, 35, 37, 55, 74, 81, 83, 93, 94, 95, 97, 108, 109, 110, 120, 137, 138, 139, 153, 154, 155, 157, 166, 167, 168, 180, 185, and 193. Examples of black pigments include Pigment Black 7, 28, and 26. Examples of white pigments include Pigment White 6, 18, and 21.

Further, even pigments that are not described in the color index can be appropriately used depending on the purpose. For example, a pigment that is surface-treated with a surfactant or a polymer dispersant, graft carbon or the like can also be used.

Examples of the polymer dispersant include polyamideamine and salts thereof, polycarboxylic acid and salts thereof, high-molecular-weight unsaturated acid esters, modified polyurethane, and polyether ester.

As the polymer dispersant, a commercially available product may be used. Examples of the commercially available product include: polymer dispersants such as DISPERBYK-101, DISPERBYK-102, DISPERBYK-103, DISPERBYK-106, DISPERBYK-111, DISPERBYK-161, DISPERBYK-162, DISPERBYK-163, DISPERBYK-164, DISPERBYK-166, DISPERBYK-167, DISPERBYK-168, DISPERBYK-170, DISPERBYK-171, DISPERBYK-174, and DISPERBYK-182 (all of which are manufactured by BYK-Chemie GmbH), EFKA4010, EFKA4046, EFKA4080, EFKA5010, EFKA5207, EFKA5244, EFKA6745, EFKA6750, EFKA7414, EFKA745, EFKA7462, EFKA7500, EFKA7570, EFKA7575, and EFKA7580 (all of which are manufactured by EFKA Additives B. V.), and DISPERSE AID 6, DISPERSE AID 8, DISPERSE AID 15, and DISPERSE AID 9100 (all of which are manufactured by SAN NOPCO LIMITED); various SOLSPERSE dispersants such as SOLSPERSE 3000, 5000, 9000, 12000, 13240, 13940, 17000, 22000, 24000, 26000, 28000, 32000, 36000, 39000, 41000, and 71000 (manufactured by The Lubrizol Corporation); and ADEKAPLURONIC L31, F38, L42, L44, L61, L64, F68, L72, P95, F77, P84, F87, P94, L101, P103, F108, L121, and P-123 (manufactured by ADEKA CORPORATION), IONET (registered trademark) S-20 (manufactured by SANYO CHEMICAL INDUSTRIES, LTD.), and DISPARLON KS-860, 873SN, and 874 (polymer dispersant), #2150 (aliphatic polyvalent carboxylic acid), and #7004 (polyether ester type) (manufactured by Kusumoto Chemicals, Ltd.).

A content ratio (polymer dispersant:pigment) between the polymer dispersant and the content in the pigment that is surface-treated with the polymer dispersant is preferably 1:1 to 1:10, more preferably 1:1 to 1:5, and still more preferably 1:2 to 1:3.

As the colorant, a commercially available product may be used. Examples of the commercially available product include Paliotol (BASF SE), Cinquasia, and Irgalite (both of which are manufactured by Ciba Specialty Chemicals Inc.), and Hostaperm (Clariant UK Ltd.).

Among the above colorants, a phthalocyanine pigment such as Phthalocyanine Blue 15:4 is preferable as the cyan pigment; an azo pigment such as Pigment Yellow 120, Pigment Yellow 151, or Pigment Yellow 155 is preferable as the yellow pigment; a quinacridone pigment such as Pigment Violet 19 or a mixed crystal quinacridone of Cinquasia MAGENTA L4540 or the like is preferable as the magenta pigment; and a carbon black pigment such as Pigment Black 7 is preferable as the black pigment.

A volume average particle size of the colorant is not particularly limited, and from the viewpoint of further improving jettability of the composition, is preferably less than 8 μm, more preferably less than 5 μm, still more preferably less than 1 μm, and still more preferably less than 0.5 μm. The lower limit of the volume average particle size of the colorant is not particularly limited, and from the viewpoint of further improving colorability and light fastness, is preferably 0.001 μm or more and more preferably 0.01 μm or more. The volume average particle size can be measured using a laser diffraction particle size distribution analyzer (for example, Mastersizer 2000, manufactured by Malvern Panalytical Ltd.; or a laser diffraction/scattering-type particle size distribution analyzer LA-920, manufactured by Horiba, Ltd.).

The lower limit value of the content of the colorant with respect to the total solid content of the composition is preferably 0.5% by mass or more, more preferably 1% by mass or more, and still more preferably 2% by mass or more. The upper limit value with respect to the total solid content of the composition is preferably 30% by mass or less, more preferably 20% by mass or less, and still more preferably 12% by mass or less.

### Photopolymerization Initiator

It is preferable that the composition includes a photopolymerization initiator.

Examples of the photopolymerization initiator include radical photopolymerization initiators such as benzophenone, 1-hydroxycyclohexyl phenyl ketone, 1-[4-(2-hydroxyethoxy)-phenyl]-2-hydroxy-2-methyl-1-propane-1-one, 2-benzyl-2-dimethylamino-(4-morpholinophenyl)butan-1-one, isopropylthioxanthone, benzyl dimethyl ketal, bis(2,4,6-trimethylbenzoyl)-phenylphosphine oxide, or bis(2,6-dimethylbenzoyl)-2,4,4-trimethylpentylphosphine oxide.

Examples of a commercially available product of the radical photopolymerization initiator include IRGACURE (registered trademark), Darocur (registered trademark), and LUCIRIN (registered trademark) (all of which are manufactured by BASF SE).

The content of the photopolymerization initiator in the composition with respect to the total solid content of the composition is preferably 1% to 20% by mass and more preferably 1% to 15% by mass.

### Organic Solvent

It is preferable that the composition includes an organic solvent.

The organic solvent is liquid at an ambient temperature, and functions as a dispersion medium or a solvent for the components in the composition. The organic solvent is not particularly limited, and can be selected from any organic solvents that are generally used in the printing industry.

A boiling point of the organic solvent is preferably 75° C. to 300° C., more preferably 90° C. to 280° C., still more preferably 100° C. to 260° C., and still more preferably 120° C. to 260° C. The boiling point of the organic solvent can be measured using a well-known method. For example, the boiling point can be measured according to JIS K 2254. In a case where the composition includes a plurality of organic solvents, the boiling point of the organic solvent is a value obtained by calculating the average value of the products of content ratios (% by mass÷100) of the organic solvents to the total mass of the organic solvents and boiling points of the organic solvents.

Examples of the organic solvent include glycol ether, glycol ether ester, an alcohol, a ketone, an ester, and pyrrolidone.

Examples of the glycol ether include ethylene glycol monomethyl ether, diethylene glycol diethyl ether, and triethylene glycol monobutyl ether.

Examples of the ketone include methyl ethyl ketone.

Examples of the ester include 3-methoxybutyl acetate and γ-butyrolactone.

Among these, diethylene glycol diethyl ether, ethylene glycol monomethyl ether, 3-methoxybutyl acetate, or γ-butyrolactone is preferable as the organic solvent.

The content of the organic solvent in the composition with respect to the total mass of the composition is preferably 20% to 90% by mass, more preferably 30% to 85% by mass, and still more preferably 40% to 80% by mass.

### Other Additives

The composition may further include components other than the above-described components.

Examples of the other components include a surfactant, a polymer, an acrylic modified polyorganosiloxane, a polymerization inhibitor, a sensitizer, an ultraviolet absorber, an antioxidant, an antifading agent, a conductive salt, and a basic compound.

### Surfactant

In order to impart stable jettability for a long time, it is also preferable that the composition includes a surfactant.

Examples of the surfactant include surfactants described in JP1987-173463A (JP-S62-173463A) and JP1987-183457A (JP-S62-183457A).

Specific example of the surfactant include: anionic surfactants such as dialkyl sulfosuccinates, alkyl naphthalene sulfonates, or fatty acid salts; nonionic surfactants such as polyoxyethylene alkyl ethers, polyoxyethylene alkyl allyl ethers, acetylene glycols, or polyoxyethylene/polyoxypropylene block copolymers; and cationic surfactants such as alkylamine salts and quaternary ammonium salts.

The content of the surfactant in the composition is appropriately selected depending on the use purpose, and is preferably 0.0001% to 1% by mass with respect to the total solid content of the composition.

### Polymer

The composition may include a polymer.

In a case where the composition includes a polymer, the polymer functions as a binder that holds the components in the composition. It is preferable that the polymer does not include a polymerizable group.

Specific examples of the polymer include an epoxy resin, polyester, a vinyl resin, an acrylic resin, and a methacrylic resin. Examples of the vinyl resin include vinyl chloride, vinyl acetate, and a copolymer of vinyl chloride and vinyl acetate. Examples of the acrylic resin and the methacrylic resin include a copolymer of methyl methacrylate and n-butyl methacrylate.

As the polymer, a commercially available product may also be used. Examples of a commercially available product of the polymer include VINNOL (registered trademark) E15/45 (a copolymer of vinyl chloride and vinyl acetate, weight-average molecular weight (Mw)=50,000) manufactured by WackerChemie AG and Elvacite 2013 (a copolymer of methyl methacrylate and n-butyl methacrylate, Mw=34,000), Elvacite 2014 (a copolymer of methyl methacrylate and n-butyl methacrylate, Mw=119,000), and Elvacite 4099 (a copolymer of methyl methacrylate and n-butyl methacrylate, Mw=15,000) manufactured by Lucite International Alpha B.V

From the viewpoint of suitably exhibiting the binder function and further improving jetting stability, the weight-average molecular weight of the polymer is preferably 10,000 to 150,000, more preferably 15,000 to 120,000, and still more preferably 20,000 to 100,000.

In a case where the composition includes a polymer, from the viewpoint of suitably exhibiting the binder function and further improving jetting stability, the content of the polymer in the composition with respect to the total mass of the composition is preferably 2% by mass or more, more preferably 2% to 10% by mass, and still more preferably 5% to 7% by mass.

### Acrylic Modified Polyorganosiloxane

It is also preferable that the composition includes an acrylic modified polyorganosiloxane having a weight-average molecular weight of 20,000 or more and 400,000 or less.

A preferable aspect and specific examples of the acrylic modified polyorganosiloxane are the same as a preferable aspect and specific examples described in WO2017/104845A (paragraphs 0122 to 0124).

### Physical Properties of Composition

A surface tension of the composition at 25° C. is preferably 20 to 40 mN/m, more preferably 22 to 30 mN/m, and still more preferably 25 to 30 mN/m. The surface tension can be measured, for example, in an environment at a temperature of 25° C. using Automatic Surface Tensiometer CBVP-Z (manufactured by Kyowa Interface Science Co., Ltd.).

A viscosity of the composition at 25° C. is preferably 200 mPa·s or less, more preferably 100 mPa·s or less, still more preferably 25 mPa·s or less, and still more preferably 10 mPa·s or less. In addition, the viscosity of the composition at 25° C. is preferably 2 mPa·s or more, more preferably 4 mPa·s or more, and still more preferably 5 mPa·s or more. The viscosity of the composition is a value measured under a condition of 25° C. (±1° C.) using VISCOMETER TV-22 (manufactured by Toki Sangyo Co., Ltd.).

### Coating Film Forming Method

### Composition (Ink) Applying Method

As a method of applying the composition to the decorative layer to form a coating film, a well-known method such as a coating method, an ink jet recording method, or a dipping method can be applied.

Examples of the coating method include a bar coater, an extrusion die coater, an air doctor coater, a blade coater, a rod coater, a knife coater, a squeeze coater, and a reverse roll coater.

A method of jetting the ink using the ink jet recording method is not particularly limited, and a well-known method, for example, any of an electric charge control method of jetting the ink using electrostatic attraction force, a drop-on-demand method (pressure pulse method) using vibration pressure of a piezoelectric element, an acoustic ink jet method of converting an electric signal into an acoustic beam, irradiating the ink with the acoustic beam, and jetting the ink by using radiation pressure, a thermal ink jet method (BUBBLE JET (registered trademark)) of heating the ink, forming bubbles, and using generated pressure may be used.

As the ink jet recording method, particularly, a method described in JP1979-059936A (JP-S54-059936A) that is an ink jet recording method of causing ink to undergo a rapid volume change due to the action of thermal energy such that the ink is jetted from a nozzle due to the acting force generated by this state change. As the ink jet recording method, a method described in paragraphs [0093] to [0105] of JP2003-306623A can also be applied.

In a case where the composition (ink) is applied to the decorative layer, it is preferable that the application is performed using an ink jet recording method of jetting ink from a nozzle of an ink jet head.

Examples of a type of the ink jet head also include a shuttle type of performing recording while scanning a short serial head in a width direction of a recording medium, and a line type using a line head in which recording elements are arranged corresponding to the entire area of one side of a recorded medium.

In the line type, image recording can be performed on the entire surface of a recording medium by scanning the recording medium in a direction intersecting the arrangement direction of the recording elements. In the line type, a transport system such as a carriage that allows the short head to perform scanning in the shuttle type is unnecessary. In addition, in the line type, as compared with the shuttle type, movement of the carriage and a complicated scanning control on the recording medium are unnecessary, and only the recording medium moves.

Therefore, according to the line type, an increase in the recording speed of an image is achieved as compared with the shuttle type.

It is preferable to perform the application of the composition (ink) using an ink jet head having a resolution of 300 dpi or higher. Here, dpi is an abbreviation for dot per inch, and 1 inch is 2.54 cm. The resolution is more preferably 600 dpi or higher and still more preferably 800 dpi or higher.

From the viewpoint of obtaining a high-definition image, the amount of liquid droplets of the composition (ink) jetted from the nozzle of the ink jet head is preferably 1 to 10 picoliter (pL) and more preferably 1.5 to 6 pL. Further, from the viewpoint of improving image unevenness and connection of continuous gradations, it is also effective to jet the ink in a combination of different amounts of liquid droplets.

The thickness of the coating film is not particularly limited, but is preferably 1 to 20 μm, more preferably 1 to 15 μm, and still more preferably 1 to 10 μm.

The ink application amount per unit area is preferably 0.1 to 30 g/m², more preferably 1 to 30 g/m², still more preferably 3 to 25 g/m², and still more preferably 3 to 20 g/m².

The ink application amount is calculated using the following method.

An image having an area of 1 m² is recorded on a substrate at a desired halftone dot rate (ratio of a portion where an image is recorded to the total area that is calculated by percentage). The mass of the recording medium before the image recording and the mass of the recording medium after the image recording are measured, and the ink application amount is calculated from a difference in mass. The ink application amount can be freely changed by setting the halftone dot rate and adjusting the amount of ink jetted from the device.

### Heating Treatment

During the coating film formation, the composition (ink) applied to the decorative layer may be heated. By heating the ink, a solvent component in the ink is volatilized to promote the drying of the ink.

A drying method is not particularly limited, and examples thereof include a method of heating the ink applied to the decorative layer using a heating device (for example, a dryer, a hot plate, or an infrared irradiation device) and a method of heating the ink by heating the recording medium (temporary support including the decorative layer) to which the ink is to be applied in advance and applying the ink to the heated recording medium.

Examples of a heating unit for heating the ink and/or the recording medium include a heat drum, hot air, an infrared lamp, an oven, a heat plate, and a hot plate.

A heating temperature of the ink and/or the recording medium is preferably 45° C. or higher, more preferably 45° C. to 100° C., and still more preferably 45° C. to 80° C.

A heating time is, for example, preferably 10 seconds or longer and 60 minutes or shorter.

### Step 3

The step 3 is a step of forming a hot melt adhesive layer on the coating film obtained in the step 2.

As a specific example of the step 3, it is preferable that the step 3 includes a step of applying a hot melt adhesive to the coating film and a step of heating and melting the hot melt adhesive applied to the coating film and cooling the melted hot melt adhesive to form a hot melt adhesive layer.

Hereinafter, first, the hot melt adhesive will be described, and then the procedure of the step 3 will be described.

### Hot Melt Adhesive

The hot melt adhesive is typically solid at normal temperature, and is an adhesive that is heated and melted to be wet and spread on a liquefied adherend and is cooled and solidified to adhere to the adherend.

The hot melt adhesive typically includes a thermoplastic resin or a thermoplastic elastomer such as a polyurethane resin, a polyester resin, a polyester polyurethane resin, a polyamide resin, a synthetic rubber, or a polyolefin resin.

Properties of the hot melt adhesive are not particularly limited, and examples thereof include a powdered hot melt adhesive, an aqueous hot melt adhesive where the thermoplastic resin is dissolved or dispersed in water, and an organic solvent-based hot melt adhesive where the thermoplastic resin is dissolved or dispersed in an organic solvent. Among these, the powdered hot melt adhesive is preferable from the viewpoint of further improving friction resistance of a transferred material obtained by transferring the transfer sheet.

As the hot melt adhesive, a well-known hot melt adhesive can be used.

Examples of a suitable form of the resin forming the hot melt adhesive include a polyester polyurethane resin consisting of hexamethylene diisocyanate (HDI), adipic acid (APA), and 1,4-butanediol (1,4-BD).

From the viewpoint of further improving blocking resistance of the transfer sheet, a weight-average molecular weight of the resin forming the hot melt adhesive is preferably 30000 or more, more preferably 50000 or more, and still more preferably 100000 or more. From the viewpoint of heating and melting during the transfer, the upper limit is preferably 350000 or less, more preferably 300000 or less, and still more preferably 250000 or less.

From the viewpoint of increasing workability during heating and transfer, a melting temperature of the resin forming the hot melt adhesive is, for example, preferably 200° C. or lower, more preferably 150° C. or lower, and still more preferably 90° C. or lower. From the viewpoint of improving heat resistance of a transferred material, the lower limit of the melting temperature is, for example, preferably 40° C. or higher, more preferably 45° C. or higher, and still more preferably 50° C. or higher.

From the viewpoint of further improving blocking resistance of the transfer sheet, a recrystallization temperature (solidification temperature) of the resin forming the hot melt adhesive is for example, preferably 45° C. or higher and more preferably 50° C. or higher. The upper limit of the recrystallization temperature is, for example, 200° C. or lower.

From the viewpoint of further improving texture of the transfer sheet, a glass transition temperature of the resin forming the hot melt adhesive is, for example, preferably 25° C. or lower, more preferably 0° C. or lower, and still more preferably −10° C. or lower. The upper limit of the glass transition temperature is, for example, 45° C. The glass transition temperature is measured as a peak temperature of tan δ (loss tangent) of the resin forming the hot melt adhesive by a dynamic viscoelasticity measuring device.

### Step of Applying Hot Melt Adhesive

The step of applying the hot melt adhesive to the coating film can be appropriately set depending on the properties of the hot melt adhesive. For example, in a case where the hot melt adhesive is the aqueous hot melt adhesive or the organic solvent-based hot melt adhesive, an ink jet coating forming method is preferable.

In a case where the hot melt adhesive is the powdered hot melt adhesive, the step of applying the hot melt adhesive to the coating film is preferably a step of spraying the hot melt adhesive from the coating film side, removing the hot melt adhesive from a portion other than the coating film, and forming the hot melt adhesive layer on the coating film.

In a case where the powdered hot melt adhesive is sprayed from the coating film side, in a portion where the coating film is present, the powdered hot melt adhesive is likely to be strongly attached to the coating film due to tackiness of the coating film. On the other hand, the powdered hot melt adhesive that is sprayed to a portion where the coating film is not present (sprayed to the portion other than the coating film) can be easily removed. Using the above-described method, in the image layer obtained by curing the coating film in the step 4, the hot melt adhesive layer can be disposed on only the image layer. As in FIG. 1, in a case where the coating film is formed on a part of the decorative layer, in a portion of the decorative layer where the coating film is not disposed, the hot melt adhesive is removed, and thus the hot melt adhesive layer is not formed.

From the viewpoint of improving friction resistance of a transferred material, in a plan view of the transfer sheet obtained through the step 4, the hot melt adhesive layer is formed such that a ratio of the area of the hot melt adhesive layer to the area of the image layer is preferably 60% to 100%. In a case where the ratio of the area of the hot melt adhesive layer to the area of the image layer is 60% or more, friction resistance of a transferred material obtained by transferring the transfer sheet is further improved. In a case where the ratio of the area of the hot melt adhesive layer to the area of the image layer is 100% or less, peelability of an image border of a transferred material obtained by transferring the transfer sheet is further improved.

### Step of Forming Hot Melt Adhesive Layer

After applying the hot melt adhesive to the coating film, the hot melt adhesive applied to the coating film is heated and melted, and the melted hot melt adhesive is cooled to form a hot melt adhesive layer.

Examples of a heating unit for heating the hot melt adhesive include a heat drum, hot air, an infrared lamp, an oven, a heat plate, and a hot plate.

A heating temperature of the hot melt adhesive is preferably +3° C. or higher, more preferably +5° C., and +10° C. with respect to the melting point of the hot melt adhesive. In addition, the heating temperature is preferably 200° C. or lower, more preferably 150° C. or lower, and still more preferably 90° C. or lower.

A heating time is, for example, preferably 5 seconds to 5 minutes.

A cooling unit for cooling the melted hot melt adhesive is not particularly limited as long as the hot melt adhesive can be cooled to a temperature where recrystallization of the resin forming the hot melt adhesive occurs. For example, air cooling can be used.

### Step 4

The step 4 is a step of curing the coating film in the laminate obtained through the step 3 to form an image layer including a (meth)acrylate resin. By performing the step 4, the polymerization reaction of the (meth)acrylate compound including the coating film progresses, and the image layer including the (meth)acrylate resin is formed.

The curing process is preferably a curing process where the polymerization reaction of the (meth)acrylate compound including the coating film progresses and is more preferably a light irradiation process.

A light source in the light irradiation process is not limited as long as it can emit light in a wavelength range where at least the coating film can be cured. Examples of the light source include various lasers, a light emitting diode (LED), an ultra-high pressure mercury lamp, a high pressure mercury lamp, and a metal halide lamp.

A peak wavelength of the irradiation light is preferably 200 to 405 nm, more preferably 220 to 395 nm, and still more preferably 260 to 395 nm.

An exposure amount is preferably more than 300 mJ/cm² and less than 1000 mJ/cm² and more preferably 350 to 800 mJ/cm².

From the viewpoint of easily adjusting the residual amount of the carbon double bond C═C in the coating film to in a predetermined range, it is preferable that the light irradiation process is performed in an atmosphere where an oxygen concentration is 180,000 volume ppm or more. The oxygen concentration is more preferably 200,000 volume ppm or more and still more preferably 210,000 volume ppm or more. The upper limit is, for example, 400,000 volume ppm or less. In particular, it is preferable that the light irradiation process is performed in the atmosphere.

In a case where the curing process in the step 4 is the light irradiation process, the residual amount of the carbon double bond C═C in the coating film can be adjusted by appropriately setting conditions such as an oxygen concentration, an illuminance, an irradiation time, and an exposure amount.

From the viewpoint of further improving the effect of the present invention, the weight-average molecular weight of the (meth)acrylate resin in the image layer formed through the step 4 is preferably 150,000 or higher and more preferably 200,000 or higher. The upper limit is not particularly limited and, for example, is preferably 500,000.

When the curing process in the step 4 is the light irradiation process, it is preferable that the light irradiation is performed from the hot melt adhesive layer side of the laminate. That is, it is preferable that the coating film is irradiated with light through the hot melt adhesive layer. In addition, it is preferable that the light irradiation process is performed on the entire surface of the laminate on the side where the hot melt adhesive layer is formed.

On the surface of the image layer formed in the step 4 on the hot melt adhesive layer side, the residual carbon double bond is adjusted such that the intensity ratio P₁ obtained from Expression (X1) is 0.005 to 0.300. From the viewpoint of further improving the effect of the present invention, the intensity ratio P₁ obtained from Expression (X1) is preferably 0.100 to 0.300.

Hereinafter, a method of measuring the intensity ratio P₁ will be described.

### Infrared Absorption Spectroscopy of Coating Film and Image Layer

Infrared absorption spectroscopy of the coating film in the transfer sheet including the uncured image layer obtained in the step 3 is performed to obtain a peak intensity derived from C═O of an ester group and a peak intensity derived from the carbon double bond C═C.

First, while emitting an ion beam to a depth direction from the hot melt adhesive layer side of the transfer sheet including the uncured image layer (coating film) obtained in the step 3, a component of the transfer sheet in the depth direction is analyzed by time-of-flight secondary ion mass spectrometry (TOF-SIMS), and the transfer sheet is dug out up to a film region of the uncured image layer (coating film) (specifically, the transfer sheet is dug out in a depth direction until, after starting to observe a secondary ion intensity derived from the component in the uncured image layer (coating film), a secondary ion intensity derived from the component in the hot melt adhesive layer is not substantially observed; here, the secondary ion intensity derived from the component in the uncured image layer (coating film) refers to an intensity of fragment ions derived from the component in the uncured image layer (coating film), and the secondary ion intensity derived from the component in the hot melt adhesive layer refers to an intensity of fragment ions derived from the component in the hot melt adhesive layer). The depth direction refers to the thickness of the coating film. In addition, the TOF-SIMS is specifically described in “Surface Analysis Technology Library Secondary Ion Mass Spectrometry” edited by the Surface Science Society of Japan and published by Maruzen Co., Ltd. (1999).

In a case where the components of the transfer sheet in the depth direction are analyzed by TOF-SIMS while performing ion sputtering, a series of operations are repeated, the operations including: performing the component analysis in a depth region of 1 to 2 nm; further digging through the transfer sheet in the depth direction by 20 nm; and performing the component analysis in the next depth region of 1 to 2 nm.

It is preferable that the measurement of the TOF-SIMS is performed under the following measurement conditions.
Used device: TRIFT V nano TOF (manufactured by Ulvac PHI Inc.)
Charge correction: combination with a low-speed electron gun
Primary ion: Bi₃+
Measurement mode: bunching mode (high mass resolution mode)
Ion beam: Ar-GCIB gun (Ar₂₅₀₀+, 20 kV, 2 nA, sputtering range: 3 mm)

Next, infrared absorption spectroscopy of the uncured image layer (coating film) that is dug out by the etching is performed to obtain a peak intensity derived from C═O of an ester group and a peak intensity derived from the carbon double bond C═C.

The infrared absorption spectroscopy of the uncured image layer (coating film) is performed by single reflection ATR for Fourier transform infrared spectroscopy (FT-IR).

Specifically, it is preferable that, using “iS5” (germanium crystal) manufactured by Thermo Fisher Scientific Inc., the infrared absorption spectroscopy is performed under conditions of a cumulative number of 32 and a TGS detector.

In an infrared absorption spectrum of the uncured image layer (coating film) obtained under the measurement conditions, an absorbance of a peak maximum value appearing in a wavelength range of 1640 to 1780 cm⁻¹ (here, a straight line connecting an absorbance at a wavelength of 1640 cm⁻¹ and an absorbance at a wavelength of 1780 cm⁻¹ is assumed as a baseline) is obtained as the peak intensity derived from C═O of the ester group. In addition, an absorbance of a peak maximum value appearing in a wavelength range of 800 to 830 cm⁻¹ (here, a straight line connecting an absorbance at a wavelength of 800 cm⁻¹ and an absorbance at a wavelength of 830 cm⁻¹ is assumed as a baseline) is obtained as the peak intensity derived from the carbon double bond C═C.

The peak intensity derived from C═O of the ester group and the peak intensity derived from the carbon double bond C═C that are obtained by the infrared absorption spectroscopy of the uncured image layer (coating film) are introduced into Expression (X2) to obtain a normalized carbon double bond peak intensity Z₁₁ of the uncured image layer (coating film). The normalized carbon double bond peak intensity Z₁₁ of the uncured image layer (coating film) obtained from Expression (X2) represents the abundance of the carbon double bond in the coating film before performing the curing reaction.

The infrared absorption spectroscopy of the coating film may be performed on the coating film formed in the step 2.

### Infrared Absorption Spectroscopy of Surface of Image Layer on Hot Melt Adhesive Layer Side

First, while emitting an ion beam to a depth direction from the hot melt adhesive layer side of the transfer sheet obtained in the step 4, a component of the transfer sheet in the depth direction is analyzed by TOF-SIMS, and the transfer sheet is dug out up to a region of a film surface of the image layer on the hot melt adhesive layer side (specifically, the transfer sheet is dug out in a depth direction until, after starting to observe a secondary ion intensity derived from the component in the image layer, a secondary ion intensity derived from the component in the hot melt adhesive layer is not observed; here, the secondary ion intensity derived from the component in the image layer refers to an intensity of fragment ions derived from the component in the image layer, and the secondary ion intensity derived from the component in the hot melt adhesive layer refers to an intensity of fragment ions derived from the component in the hot melt adhesive layer). In addition, the depth direction refers to the thickness of the image layer.

In a case where the components of the transfer sheet in the depth direction are analyzed by TOF-SIMS while performing ion sputtering, a series of operations are repeated, the operations including: performing the component analysis in a depth region of 1 to 2 nm; further digging through the transfer sheet in the depth direction by 20 nm; and performing the component analysis in the next depth region of 1 to 2 nm.

It is preferable that the measurement of the TOF-SIMS is performed under the following measurement conditions.
Used device: TRIFT V nano TOF (manufactured by Ulvac PHI Inc.)
Charge correction: combination with a low-speed electron gun
Primary ion: Bi₃+
Measurement mode: bunching mode (high mass resolution mode)
Ion beam: Ar-GCIB gun (Ar₂₅₀₀+, 20 kV, 2 nA, sputtering range: 3 mm)

Next, infrared absorption spectroscopy of the surface of the image layer on the hot melt adhesive side that is dug out by the etching is performed to obtain a peak intensity derived from C═O of an ester group and a peak intensity derived from the carbon double bond C═C.

The infrared absorption spectroscopy of the surface of the image layer on the hot melt adhesive side is performed by single reflection ATR for Fourier transform infrared spectroscopy (FT-TR). Specifically, it is preferable that, using “iS5” (germanium crystal) manufactured by Thermo Fisher Scientific Inc., the infrared absorption spectroscopy is performed under conditions of a cumulative number of 32 and a TGS detector.

In an infrared absorption spectrum obtained under the measurement conditions, an absorbance of a peak maximum value appearing in a wavelength range of 1640 to 1780 cm⁻¹ (here, a straight line connecting an absorbance at a wavelength of 1640 cm⁻¹ and an absorbance at a wavelength of 1780 cm⁻¹ is assumed as a baseline) is obtained as the peak intensity derived from C═O of the ester group. In addition, an absorbance of a peak maximum value appearing in a wavelength range of 800 to 830 cm⁻¹ (here, a straight line connecting an absorbance at a wavelength of 800 cm⁻¹ and an absorbance at a wavelength of 830 cm⁻¹ is assumed as a baseline) is obtained as the peak intensity derived from the carbon double bond C═C.

The peak intensity derived from C═O of the ester group and the peak intensity derived from the carbon double bond C═C that are obtained by the infrared absorption spectroscopy of the surface of the image layer on the hot melt adhesive side are introduced into Expression (X3) to obtain a normalized carbon double bond peak intensity Z₁₂ of the surface of the image layer on the hot melt adhesive side. The normalized carbon double bond peak intensity Z₁₂ of the surface of the image layer on the hot melt adhesive layer side formed in the step 4 that is obtained from Expression (X3) represents the content of the carbon double bond in the image layer.

The values of the normalized carbon double bond peak intensity Z₁₁ of the uncured image layer (coating film) formed in the step 3 and the normalized carbon double bond peak intensity Z₁₂ of the surface of the image layer on the hot melt adhesive layer side formed in the step 4 that are obtained using the above-described method are introduced into Expression (X1) to obtain the peak intensity ratio P₁.

### Transfer Method

A transfer sheet obtained using the manufacturing method according to the embodiment of the present invention can be suitably used for textile printing on fabric.

Examples of the fiber type of the fabric include synthetic fibers such as nylon, polyester, or acrylonitrile; semi-synthetic fibers such as acetate or rayon; natural fibers such as cotton, silk, or wool; and mixed fibers consisting of two or more selected from the group consisting of the synthetic fibers, the semi-synthetic fibers, and the natural fibers.

As the fiber type in the fabric, cellulose fibers are preferable, and cotton is more preferable.

Examples of the aspect of the fabric include web, knitted fabric, and nonwoven fabric. The fabric may be fabric for a fabric product.

Examples of the fabric product include clothing items (T-shirts, sweatshirts, jerseys, pants, sweatsuits, dresses, and blouses), bedding, and handkerchiefs.

### Transfer Step

Hereinafter, an example of an embodiment of a step of transferring the transfer layer of the transfer sheet obtained using the manufacturing method according to the embodiment of the present invention to fabric will be described using the step of transferring the transfer layer 20 of the transfer sheet 10 of FIG. 1 to fabric as an example.

First, the transfer sheet 10 and the fabric that is a transfer target material are laminated such that the surface of the transfer sheet 10 on the hot melt adhesive layer 18 side and the fabric are in contact with each other, and the laminate including the transfer layer 20 of the transfer sheet 10 and the fabric is heated (thermal compression). Next, the temporary support 12 and the decorative layer 14 of a portion where the image layer 16 is not formed (in FIG. 1, the decorative layer 14 positioned in an opening portion of the image layer 16) are peeled off. By curing the transferred material after peeling the temporary support 12 and the decorative layer 14, the residual carbon double bond of the image layer 16 is polymerized and the image layer 16 is completely cured to obtain a transferred material.

Hereinafter, a specific procedure will be described.

### Thermal Compression Step

Examples of a method of transferring the transfer layer of the transfer sheet to the fabric include a method of laminating the transfer sheet and the fabric in a state where the transfer layer and the fabric are in contact with each other, and heating the laminate.

A heating temperature is, for example, preferably 100° C. to 200° C.

A heating time is, for example, preferably 20 seconds to 5 minutes.

For the transfer, a commercially available heat press machine can be used. Examples of the heat press machine include a desktop automatic flat press machine AF-54TEN type (manufactured by Asahi Garment Machinery Co., Ltd.) and ZEUS PZ-130110D (manufactured by Europort LS).

### Curing Step

Next, it is preferable that the transferred material after the heat treatment is cured. Due to the curing process, the polymerization reaction of the residual carbon double bond in the image layer progresses, the strength of the image layer is further improved, and adhesiveness between the transfer target material and the transfer layer is further improved. As a result, the obtained transferred material has excellent friction resistance.

The curing process is preferably a curing process where the polymerization reaction of the residual carbon double bond including the image layer progresses and is more preferably a light irradiation process.

Examples of the light source in the light irradiation process include various lasers, a light emitting diode (LED), an ultra-high pressure mercury lamp, a high pressure mercury lamp, and a metal halide lamp.

A peak wavelength of the irradiation light is preferably 200 to 405 nm, more preferably 220 to 395 nm, and still more preferably 260 to 395 nm.

An exposure amount is preferably 500 to 5,000 mJ/cm² and more preferably 1,000 to 1,500 mJ/cm².

It is preferable that the light irradiation process is performed in a low-oxygen atmosphere where the oxygen concentration is 1,000 volume ppm or less such that polymerization inhibition does not occur.

The oxygen concentration is more preferably 500 volume ppm or less and still more preferably 100 volume ppm or less. The lower limit is, for example, 10 volume ppm or more.

### Transfer Sheet

A transfer sheet according to an embodiment of the present invention
is a transfer sheet obtained using the above-described manufacturing method according to the embodiment of the present invention,
the transfer sheet comprising, in the following order:
a temporary support;
a decorative layer;
an image layer; and
a hot melt adhesive layer,
in which the image layer includes one or more kinds selected from the group consisting of an acrylate resin and a methacrylate resin,
an intensity ratio P₂ obtained from Expression (Y1) is 1.25 to 50.0,

$${P}_{2} = {Z}_{22} / {Z}_{21} , \qquad Expression ( Y1 )$$

in Expression (Y1), P₂ represents the intensity ratio,
Z₂₁ represents a normalized carbon double bond peak intensity of a surface of the image layer on the decorative layer side obtained from Expression (Y2), and
Z₂₂ represents a normalized carbon double bond peak intensity of a surface of the image layer on the hot melt adhesive layer side obtained from Expression (Y3),

$${Z}_{21} = {Y}_{21} / {X}_{21} , \qquad Expression ( Y2 )$$

in Expression (Y2), X₂₁ represents a peak intensity derived from C═O of an ester group obtained by infrared absorption spectroscopy of the surface of the image layer on the decorative layer side,
Y₂₁ represents a peak intensity derived from a carbon double bond C═C obtained by the infrared absorption spectroscopy of the surface of the image layer on the decorative layer side, and
Z₂₁ represents the normalized carbon double bond peak intensity,

$${Z}_{22} = {Y}_{22} / {X}_{22} , \qquad Expression ( Y3 )$$

in Expression (Y3), X₂₂ represents a peak intensity derived from C═O of an ester group obtained by infrared absorption spectroscopy of the surface of the image layer on the hot melt adhesive layer side,
Y₂₂ represents a peak intensity derived from a carbon double bond C═C obtained by the infrared absorption spectroscopy of the surface of the image layer on the hot melt adhesive layer side, and
Z₂₂ represents the normalized carbon double bond peak intensity.

The transfer sheet according to the embodiment of the present invention has excellent blocking resistance and excellent friction resistance of a transferred material.

Examples of main feature points of the transfer sheet according to the embodiment of the present invention include a point that a residual carbon double bond in the surface of the image layer on the hot melt adhesive layer side is adjusted to be in a predetermined range (the intensity ratio P₂ obtained from Expression (Y1) is 1.25 to 50.0).

As described below, a transfer method to a transfer target material using the transfer sheet according to the embodiment of the present invention is preferably a method including: forming a laminate by laminating and heating (thermal compression) the transfer sheet and a transfer target material such that the surface of the transfer sheet on the hot melt adhesive layer side and the transfer target material are in contact with each other; peeling the temporary support; and curing the transferred material from which the temporary support is peeled off to polymerize the residual carbon double bond of the image layer such that the image layer is completely cured.

In the transfer sheet according to the embodiment of the present invention having the above-described feature point, the intensity ratio P₂ obtained from Expression (Y1) is 1.25 or more. As a result, the transfer sheet exhibits flexibility required for transfer during transfer, and is likely to be transferred along unevenness of a transfer target material. Further, by curing the image layer in the transferred material by light irradiation or the like to polymerize the residual carbon double bond, the image layer in the transferred material is cured, and thus the transferred material can be more strongly adhered. As a result, it is presumed that the transferred material has excellent friction resistance. Typically, in a case where a transfer layer such as a metal foil or a metal deposition layer having excellent smoothness that includes the decorative layer (the transfer layer refers to a layer that is formed on the temporary support and is to be transferred to a transfer target material; the transfer layer includes the decorative layer, the image layer, and the hot melt adhesive layer) is desired to be transferred to an uneven substrate such as fabric, the transfer layer is not likely to follow the uneven substrate. Therefore, a physical anchor effect does not act between the transfer layer and the uneven substrate, and the obtained transferred material tends to have poor friction resistance. On the other hand, in a case where the transfer sheet according to the embodiment of the present invention includes the decorative layer such as a metal foil or a metal deposition layer due to the above-described action mechanism, the transfer sheet is likely to follow unevenness of a transfer target material, and a physical anchor effect is likely to act between the transfer layer and the uneven substrate. In addition, by curing the image layer in the transferred material by light irradiation or the like to polymerize the residual carbon double bond, the transferred material and the uneven substrate can be more strongly adhered to each other.

In addition, the intensity ratio P₂ obtained from Expression (Y1) is 50.0 or less. As a result, it is presumed that the image layer is not excessively flexible, and the transfer sheet has excellent blocking resistance.

Hereinafter, in the transfer sheet according to the embodiment of the present invention, blocking resistance and/or higher friction resistance of a transferred material being further improved will also be referred to as “the effect of the present invention being further improved”.

Hereinafter, the configuration of the transfer sheet according to the embodiment of the present invention will be described.

The transfer sheet according to the embodiment of the present invention can be formed using the method for manufacturing a transfer sheet according to the embodiment of the present invention. An example of the embodiment of the transfer sheet according to the embodiment of the present invention is the transfer sheet 10 shown in FIG. 1 described as the transfer sheet that can be formed using the method for manufacturing a transfer sheet according to the embodiment of the present invention.

The transfer sheet 10 shown in FIG. 1 has the form where the decorative layer 14 is disposed on the entire surface of a main surface of the temporary support 12. However, the decorative layer 14 may be disposed on a part of the main surface of the temporary support 12.

In addition, the transfer sheet 10 shown in FIG. 1 has the form where the image layer 16 is partially disposed on the decorative layer 14. However, the image layer 16 may be disposed on the entire surface of the decorative layer 14.

In addition, the transfer sheet 10 shown in FIG. 1 has the form where the hot melt adhesive layer 18 is disposed on the entire surface of the image layer 16. However, the hot melt adhesive layer 18 may be disposed on a part of the image layer 16, or may be disposed to cover the image layer 16.

Hereinafter, each of the configurations of the transfer sheet according to the embodiment of the present invention will be described.

### Temporary Support

The transfer sheet according to the embodiment of the present invention includes the temporary support.

The temporary support is a member that supports the transfer layer such as the image layer disposed on the temporary support. In a case where the transfer sheet is used, the temporary support is peeled off from the transfer sheet after transferring the transfer layer to a transfer target material. A specific form of the temporary support is the above-described temporary support used in the step 1 of the method for manufacturing a transfer sheet according to the embodiment of the present invention, and a preferable aspect is also the same.

### Decorative Layer

The transfer sheet according to the embodiment of the present invention includes the decorative layer.

It is preferable that the decorative layer is a layer for further improving the designability of the image layer and is a layer having excellent glossiness. A specific form of the decorative layer is the above-described decorative layer used in the step 1 of the method for manufacturing a transfer sheet according to the embodiment of the present invention, and a preferable aspect is also the same.

### Image Layer

The transfer sheet according to the embodiment of the present invention includes the image layer.

The image layer includes one or more kinds selected from the group consisting of (meth)acrylate resins.

From the viewpoint of further improving the effect of the present invention, the weight-average molecular weight of the (meth)acrylate resin in the image layer is preferably 150,000 or higher and more preferably 200,000 or higher. The upper limit is not particularly limited and, for example, is preferably 500,000.

The image layer is preferably a cured layer derived from a composition including a (meth)acrylate compound (preferably a cured layer obtained by curing (photocuring) a composition including a (meth)acrylate compound). Specific examples of the composition including a (meth)acrylate compound include the composition (ink) including the (meth)acrylate compound described in the step 2 of the method for manufacturing a transfer sheet according to the embodiment of the present invention, and a preferable aspect is also the same.

In addition, in the image layer, the intensity ratio P₂ obtained from Expression (Y1) is 1.25 to 50.0. The residual carbon double bond of the surface of the image layer on the hot melt adhesive layer side is adjusted such that the intensity ratio P₂ obtained from Expression (Y1) is 1.25 to 50.0.

From the viewpoint of easily further improving the effect of the present invention, the intensity ratio P₂ obtained from Expression (Y1) is preferably 5.00 to 50.0 and more preferably 15.0 to 48.0.

Hereinafter, a method of measuring the intensity ratio P₂ will be described.

### Infrared Absorption Spectroscopy of Surface of Image Layer on Hot Melt Adhesive Layer Side

First, while emitting an ion beam to a depth direction from the hot melt adhesive layer side of the transfer sheet, a component of the transfer sheet in the depth direction is analyzed by TOF-SIMS, and the transfer sheet is dug out up to a region of a film surface of the image layer on the hot melt adhesive layer side (specifically, the transfer sheet is dug out in a depth direction until, after starting to observe a secondary ion intensity derived from the component in the image layer, a secondary ion intensity derived from the component in the hot melt adhesive layer is not observed; here, the secondary ion intensity derived from the component in the image layer refers to an intensity of fragment ions derived from the component in the image layer, and the secondary ion intensity derived from the component in the hot melt adhesive layer refers to an intensity of fragment ions derived from the component in the hot melt adhesive layer). In addition, the depth direction refers to the thickness of the image layer.

In a case where the components of the transfer sheet in the depth direction are analyzed by TOF-SIMS while performing ion sputtering, a series of operations are repeated, the operations including: performing the component analysis in a depth region of 1 to 2 nm; further digging through the transfer sheet in the depth direction by 20 nm; and performing the component analysis in the next depth region of 1 to 2 nm.

It is preferable that the measurement of the TOF-SIMS is performed under the following measurement conditions.
Used device: TRIFT V nano TOF (manufactured by Ulvac PHI Inc.)
Charge correction: combination with a low-speed electron gun
Primary ion: Bi₃
Measurement mode: bunching mode (high mass resolution mode)
Ion beam: Ar-GCIB gun (Ar₂₅₀₀+, 20 kV, 2 nA, sputtering range: 3 mm)

Next, infrared absorption spectroscopy of the surface of the image layer on the hot melt adhesive side that is dug out by the etching is performed to obtain a peak intensity derived from C═O of an ester group and a peak intensity derived from the carbon double bond C═C.

The infrared absorption spectroscopy of the surface of the image layer on the hot melt adhesive side is performed by single reflection ATR for Fourier transform infrared spectroscopy (FT-TR). Specifically, it is preferable that, using “iS5” (germanium crystal) manufactured by Thermo Fisher Scientific Inc., the infrared absorption spectroscopy is performed under conditions of a cumulative number of 32 and a TGS detector.

In an infrared absorption spectrum obtained under the measurement conditions, an absorbance of a peak maximum value appearing in a wavelength range of 1640 to 1780 cm⁻¹ (here, a straight line connecting an absorbance at a wavelength of 1640 cm⁻¹ and an absorbance at a wavelength of 1780 cm⁻¹ is assumed as a baseline) is obtained as the peak intensity derived from C═O of the ester group. In addition, an absorbance of a peak maximum value appearing in a wavelength range of 800 to 830 cm⁻¹ (here, a straight line connecting an absorbance at a wavelength of 800 cm⁻¹ and an absorbance at a wavelength of 830 cm⁻¹ is assumed as a baseline) is obtained as the peak intensity derived from the carbon double bond C═C.

The peak intensity derived from C═O of the ester group and the peak intensity derived from the carbon double bond C═C that are obtained by the infrared absorption spectroscopy of the surface of the image layer on the hot melt adhesive side are introduced into Expression (Y3) to obtain a normalized carbon double bond peak intensity Z₂₂ of the surface of the image layer on the hot melt adhesive side. The normalized carbon double bond peak intensity Z₂₂ of the surface of the image layer on the hot melt adhesive layer side that is obtained from Expression (Y₃) represents the content of the carbon double bond in the surface of the image layer on the hot melt adhesive side.

### Infrared Absorption Spectroscopy of Surface of Image Layer on Decorative Layer Side

Infrared absorption spectroscopy of the surface of the image layer on the decorative layer side is performed through the same procedure as that of the infrared absorption spectroscopy of the surface of the image layer on the hot melt adhesive layer side.

In the infrared absorption spectroscopy of the surface of the image layer on the decorative layer side, through the above-described procedure, while emitting an ion beam to a depth direction from the hot melt adhesive layer side of the image layer, a component of the transfer sheet in the depth direction is analyzed by TOF-SIMS, and the transfer sheet is dug out up to a region of a film surface of the image layer on the decorative layer side (specifically, the transfer sheet is dug out, preferably, up to a depth region immediately before starting to observe a secondary ion intensity derived from the component of the decorative layer, for example, up to a depth position of 2 nm from an interface of the decorative layer side of the image layer.

Next, infrared absorption spectroscopy of the surface of the image layer on the decorative layer side that is dug out by the etching is performed to obtain a peak intensity derived from C═O of an ester group and a peak intensity derived from the carbon double bond C═C.

The infrared absorption spectroscopy of the surface of the image layer on the decorative layer side is performed by single reflection ATR for Fourier transform infrared spectroscopy (FT-IR). Specifically, it is preferable that, using “iS5” (germanium crystal) manufactured by Thermo Fisher Scientific Inc., the infrared absorption spectroscopy is performed under conditions of a cumulative number of 32 and a TGS detector.

In an infrared absorption spectrum obtained under the measurement conditions, an absorbance of a peak maximum value appearing in a wavelength range of 1640 to 1780 cm⁻¹ (here, a straight line connecting an absorbance at a wavelength of 1640 cm⁻¹ and an absorbance at a wavelength of 1780 cm⁻¹ is assumed as a baseline) is obtained as the peak intensity derived from C═O of the ester group. In addition, an absorbance of a peak maximum value appearing in a wavelength range of 800 to 830 cm⁻¹ (here, a straight line connecting an absorbance at a wavelength of 800 cm⁻¹ and an absorbance at a wavelength of 830 cm⁻¹ is assumed as a baseline) is obtained as the peak intensity derived from the carbon double bond C═C.

The peak intensity derived from C═0 of the ester group and the peak intensity derived from the carbon double bond C═C that are obtained by the infrared absorption spectroscopy of the surface of the image layer on the decorative layer side are introduced into Expression (Y2) to obtain a normalized carbon double bond peak intensity Z₂₁ of the surface of the image layer on the decorative layer side. The normalized carbon double bond peak intensity Z₂₁ of the surface of the image layer on the decorative layer side that is obtained from Expression (Y2) represents the content of the carbon double bond in the surface of the image layer on the decorative layer side.

Typically, the content of the carbon double bond in the surface of the image layer on the decorative layer side is significantly low. The reason for this is that, in a case where the composition layer formed of the composition including the (meth)acrylate compound is photocured to form the image layer, the oxygen concentration decreases toward a deep portion region of the composition layer such that radical polymerization inhibition is not likely to occur, and the polymerization reaction is likely to progress. That is, in the surface of the image layer on the decorative layer side, the above-described polymerization reaction sufficiently progresses, and the content of the residual carbon double bond is significantly low.

Next, the values of the normalized carbon double bond peak intensity Z₂₁ of the surface of the image layer on the decorative layer side that is obtained from Expression (Y2) and the normalized carbon double bond peak intensity Z₂₂ of the surface of the image layer on the hot melt adhesive layer side that is obtained from Expression (Y3) are introduced into Expression (Y₁) to obtain the peak intensity ratio P₂. In the transfer sheet according to the embodiment of the present invention, the content of the residual carbon double bond in the surface of the image layer on the hot melt adhesive layer side is adjusted with respect to the content of the carbon double bond in the surface of the image layer on the decorative layer side. In a case where the intensity ratio P₂ of the image layer obtained from Expression (Y1) satisfies 1.25 to 50.0, the transfer sheet has excellent blocking resistance and excellent friction resistance of a transferred material.

### Hot Melt Adhesive Layer

The transfer sheet according to the embodiment of the present invention includes the hot melt adhesive layer.

The hot melt adhesive layer is a layer formed of the hot melt adhesive. The hot melt adhesive layer is typically a layer formed by heating and melting the composition layer of the hot melt adhesive and cooling the melted hot melt adhesive.

Examples of the hot melt adhesive include the same examples of the hot melt adhesive used in the step 3 of the method for manufacturing a transfer sheet according to the embodiment of the present invention, and a preferable aspect thereof is also the same.

Typical examples of the resin forming the hot melt adhesive layer include a thermoplastic resin or a thermoplastic elastomer such as a polyurethane resin, a polyester resin, a polyester polyurethane resin, a polyamide resin, a synthetic rubber, or a polyolefin resin.

From the viewpoint of further improving blocking resistance of the transfer sheet, a weight-average molecular weight of the resin forming the hot melt adhesive is preferably 30000 or more, more preferably 50000 or more, and still more preferably 100000 or more. From the viewpoint of heating and melting during the transfer, the upper limit is preferably 350000 or less, more preferably 300000 or less, and still more preferably 250000 or less.

From the viewpoint of further improving adhesiveness, the lower limit value of the thickness of the hot melt adhesive layer is preferably 1 μm or more and more preferably 3 μm or more. From the viewpoint of texture of a transfer target material, the upper limit value is, for example, 200 μm or less and preferably 100 μm or less.

From the viewpoint of improving friction resistance of a transferred material, in a plan view of the transfer sheet, the hot melt adhesive layer is disposed such that a ratio of the area of the hot melt adhesive layer to the area of the image layer is preferably 60% to 100%. In a case where the ratio of the area of the hot melt adhesive layer to the area of the image layer is 60% or more, friction resistance of a transferred material obtained by transferring the transfer sheet is further improved. In a case where the ratio of the area of the hot melt adhesive layer to the area of the image layer is 100% or less, peelability of an image border of a transferred material obtained by transferring the transfer sheet is further improved.

### Transfer Method

The transfer sheet according to the embodiment of the present invention can be suitably used for textile printing on fabric.

Examples of the fabric as the transfer target material include the same examples of the fabric described as the transfer target material in the transfer method using the transfer sheet obtained in the method for manufacturing a transfer sheet according to the embodiment of the present invention.

In addition, the transfer method using the transfer sheet according to the embodiment of the present invention is the same as the transfer method using the transfer sheet obtained using the method for manufacturing a transfer sheet according to the embodiment of the present invention, and a preferable aspect thereof is also the same.

### EXAMPLES

The present invention will be described in more detail based on the following examples. Materials, used amounts, ratios, treatment details, treatment procedures, and the like shown in the following examples can be appropriately changed within a range not departing from the scope of the present invention. Accordingly, the scope of the present invention is not limited to the following examples.

Hereinafter, unless specified otherwise, “part(s)” and “%” represent “part(s) by mass” and “% by mass”, respectively.

### Preparation and Evaluation of DTF Sheet of Example 1

### Preparation of Pigment Dispersion

Components other than a pigment shown in Table 1 were mixed to obtain a composition of Table 1, and were stirred using a mixer manufactured by Silverson Machines Ltd. under conditions of 2,000 to 3,000 rotations/min and 10 to 15 minutes to obtain a uniform dispersant diluted liquid. Each of the pigments having a kind and an amount shown in Table 1 was added to the dispersant diluted liquid, and the solution was further stirred using the mixer under conditions of 2,000 to 3,000 rotations/min and 10 to 20 minutes to obtain 500 parts of a uniform preliminary dispersion liquid.

Next, each of the obtained preliminary dispersion liquids was dispersed using a circulation type beads mill (DISPERMAT SL-012C1) to obtain a pigment dispersion of each of the colors. As conditions of the dispersion process, the circulation type beads mill was filled with 200 parts of zirconia beads having a diameter of 0.65 mm, and a circumferential speed was 15 m/s. A dispersion time was 1 to 6 hours.

TABLE 1

| | Pigment Mill | Pigment Mill | Pigment Mill | Pigment Mill |
|---|---|---|---|---|
| | Base Cyan | Base Magenta | Base Yellow | Base Black |
| Pigment | PB15:4 | Mixed | PY120 | Carbon Black |
| | | Quinacridone | | |
| | 30% by mass | 30% by mass | 30% by mass | 30% by mass |
| Dispersant | Sol32000 | Sol32000 | Sol32000 | Sol32000 |
| | 10% by mass | 15% by mass | 10% by mass | 10% by mass |
| DEGDEE | 60% by mass | 55% by mass | 60% by mass | 60% by mass |

The details of the components in Table 1 are as follows.
PB15:4 C. I. Pigment Blue 15:4 (HELIOGEN BLUE D 7110F, manufactured by BASF SE)
Mixed quinacridone CINQUASIA MAGENTA L 4540, manufactured by BASF SE
PY120 C. I. Pigment Yellow 120 (NOVOPERM YELLOW H2G, manufactured by Clariant)
Carbon black MOGUL E, manufactured by CABOT Corporation
Sol32000 SOLSPERSE 32000, manufactured by Lubrizol Corporation
DEGDEE diethylene glycol diethyl ether, manufactured by Tokyo Chemical Industry Co., Ltd.

### Preparation of Ink

The image layer ink was prepared by mixing components according to the following composition 1 and stirring the mixture using a mixer manufactured by Silverson Machines Ltd. under conditions of 2,000 to 3,000 rotations/min and 10 to 15 minutes. While an example where pigment Mill Base Black was used as a pigment dispersion is described below, an image layer ink of a different color was also prepared by the same procedure.

### —Composition 1 of Ink—

Pigment dispersion: pigment Mill Base Black: 5 parts
Organic solvent: diethylene glycol diethyl ether (manufactured by Tokyo Chemical Industry Co., Ltd.): 71.9 parts
Polymerizable compound: GENOMER 4215 (bifunctional urethane (meth)acrylate oligomer, manufactured by Rahn AG): 20 parts
Polymerization initiator: IRGACURE 819 (manufactured by BASF SE): 2 parts
Polymerization initiator: IRGACURE 2959 (manufactured by BASF SE): 1 part
Surfactant: BYK331 (manufactured by BYK Japan K.K.): 0.1 parts

### Image Recording Device

As an ink jet recording device, a device where a rubber heater (manufactured by Three High Co., Ltd.), an UV exposure machine (LED-UV lamp) (LLRG1200FUV, manufactured by AITEC SYSTEM Co., Ltd.), and a low-pressure mercury lamp (a bactericidal lamp GL15, manufactured by Hitachi Global Life Solutions, Inc.) were attached to an ink jet printer (KEGON) manufactured by Afit Corporation was prepared.

The output of the rubber heater was set such that a back surface temperature of a recording medium was increased from 35° C. to 90° C.

### Method of Forming Image Layer

With the following configurations, an image was recorded to form an image layer. Each of the configurations is as follows.

By performing an ink jetting step and an ink heating step in this order, an image layer was formed.

As a temporary support, a PET film (COSMOSHINE A4100, manufactured by Toyobo Co., Ltd., thickness: 50 μm) with an easy adhesion layer on one side was prepared. A gold foil sheet was laminated on a surface (that is, on a PET film surface) of the temporary support where the easy adhesion layer was not provided, and this laminate was set as a recording medium.

### (1) Ink Jetting Step:

Black (K) ink was repeatedly jetted in a line shape to the recording medium from an ink jet head (CA4, manufactured by Toshiba Tec Corporation, nozzle diameter: 26 μm) heated to 35° C. such that an image density of 1200 dpi×600 dpi (dot per inch) was obtained. In this case, a voltage was adjusted such that the amount of ink jetted was 20 g per 1 m².

### (2) Ink Heating Step:

The recording medium to which the ink was jetted was heated using the rubber heater such that a back surface temperature of the recording medium was 45° C. As a result, an image layer was formed. A heating time was set to 10 seconds. The back surface temperature of the recording medium was measured using an infrared thermometer (AD-5616, manufactured by A&D Co., Ltd.).

### Method of Applying Hot Melt Adhesive

Hot melt powder (product name “O-Powder”, manufactured by SELCAM CO., LTD.) was sprayed to the recording medium from the image layer surface to apply the hot melt powder to the image layer. The hot melt powder was attached to the image due to tackiness of the uncured image layer to form the same image as the image layer.

### Baking Method of Hot Melt Adhesive

The recording medium was heated at 150° C. for 1 minute to heat and melt (bake) the hot melt adhesive layer, and then was air-cooled to room temperature and recrystallized to form a hot melt adhesive layer. As a result, an uncured DTF sheet was obtained.

### Image Layer Curing Step

Regarding the recording medium to which the hot melt adhesive layer was formed, the entire surface on the side where the hot melt adhesive layer was formed was irradiated with ultraviolet rays. Using an UV exposure machine (LED-UV lamp, wavelength: 385 nm) as a light source for emitting ultraviolet rays, the ultraviolet rays were emitted in the atmosphere at an exposure amount of 500 mJ/cm². As a result, the image layer was cured to obtain a DTF sheet.

### Measurement of IR Peak

Calculation of Intensity Ratio P₁
Measurement of IR Peak of DTF Sheet

By etching the DTF sheet in the following procedure using TOF-SIMS, a surface region of the image layer on the hot melt adhesive layer side was dug out. The etching was performed from the hot melt adhesive layer side. In addition, etching conditions are as follows.
Used device: TRIFT V nano TOF (manufactured by Ulvac PHI Inc.)
Charge correction: combination with a low-speed electron gun
Primary ion: Bi₃+
Measurement mode: bunching mode (high mass resolution mode)
Ion beam: Ar-GCIB gun (Ar₂₅₀₀+, 20 kV, 2 nA, sputtering range: 3 mm)

Next, the measurement of the IR peak of the surface of the image layer on the hot melt adhesive layer side that was dug out by etching was performed. Specifically, the surface of the image layer on the hot melt adhesive layer side that was dug out by etching was measured by FT-IR/single reflection ATR (crystal: Ge).
Device: iS5 (manufactured by Thermo Fisher Scientific Inc.)
Detector: TGS, cumulative number: 32 times (Ge)

A peak maximum value at 1640 to 1780 cm⁻¹ derived from C═O of an ester group (a straight line connecting an absorbance at 1640 cm⁻¹ and an absorbance at 1780 cm⁻¹ is assumed as a baseline) is represented by X₁₂, a peak maximum value at 800 to 830 cm⁻¹ derived from a carbon double bond C═C (a straight line connecting an absorbance at 800 cm⁻¹ and an absorbance at 830 cm⁻¹ is assumed as a baseline) is represented by Y₁₂, and By introducing each of the numerical values into Expression (X3), the normalized carbon double bond peak intensity Z₁₂ was obtained.

### Measurement of IR Peak of Uncured DTF Sheet

By etching the uncured DTF sheet in the following procedure using TOF-SIMS, a region of the uncured image layer (coating film) was dug out. The etching was performed from the hot melt adhesive layer side. In addition, etching conditions are as follows.
Used device: TRIFT V nano TOF (manufactured by Ulvac PHI Inc.)
Charge correction: combination with a low-speed electron gun
Primary ion: Bi₃+
Measurement mode: bunching mode (high mass resolution mode)
Ion beam: Ar-GCIB gun (Ar₂₅₀₀+, 20 kV, 2 nA, sputtering range: 3 mm)

Next, the measurement of the IR peak of the uncured image layer (coating film) that was dug out by etching was performed. Specifically, the uncured image layer (coating film) was measured by FT-IR/single reflection ATR (crystal: Ge).
Device: iS5 (manufactured by Thermo Fisher Scientific Inc.)
Detector: TGS, cumulative number: 32 times (Ge)

A peak maximum value at 1640 to 1780 cm⁻¹ derived from C═O of an ester group (a straight line connecting an absorbance at 1640 cm⁻¹ and an absorbance at 1780 cm⁻¹ is assumed as a baseline) is represented by X₁₁, a peak maximum value at 800 to 830 cm⁻¹ derived from a carbon double bond C═C (a straight line connecting an absorbance at 800 cm⁻¹ and an absorbance at 830 cm⁻¹ is assumed as a baseline) is represented by Y₁₁, and By introducing each of the numerical values into Expression (X2), the normalized carbon double bond peak intensity Z₁₁ was obtained.

### Intensity Ratio P₁

The numerical values of the normalized carbon double bond peak intensity Z₁₁ of the uncured DTF sheet and the normalized carbon double bond peak intensity Z₁₂ of the cured DTF sheet were introduced into Expression (X1) to obtain the intensity ratio P₁.

### Calculation of Intensity Ratio P₂

### Measurement of IR Peak of Surface of Image Layer of DTF Sheet on Hot Melt Adhesive Layer Side

By etching the DTF sheet in the following procedure using TOF-SIMS, a surface region of the image layer on the hot melt adhesive layer side was dug out. The etching was performed from the hot melt adhesive layer side. In addition, etching conditions are as follows.
Used device: TRIFT V nano TOF (manufactured by Ulvac PHI Inc.)
Charge correction: combination with a low-speed electron gun
Primary ion: Bi₃+
Measurement mode: bunching mode (high mass resolution mode)
Ion beam: Ar-GCIB gun (Ar₂₅₀₀+, 20 kV, 2 nA, sputtering range: 3 mm)

Next, the measurement of the IR peak of the surface of the image layer on the hot melt adhesive layer side that was dug out by etching was performed. Specifically, the surface of the image layer on the hot melt adhesive layer side was measured by FT-IR/single reflection ATR (crystal: Ge).
Device: iS5 (manufactured by Thermo Fisher Scientific Inc.), Detector: TGS, Cumulative number: 32 times (Ge)

A peak maximum value at 1640 to 1780 cm⁻¹ derived from C═O of an ester group (a straight line connecting an absorbance at 1640 cm⁻¹ and an absorbance at 1780 cm⁻¹ is assumed as a baseline) is represented by X₂₂, a peak maximum value at 800 to 830 cm⁻¹ derived from a carbon double bond C═C (a straight line connecting an absorbance at 800 cm⁻¹ and an absorbance at 830 cm⁻¹ is assumed as a baseline) is represented by Y₂₂, and By introducing each of the numerical values into Expression (Y3), the normalized carbon double bond peak intensity Z₂₂ was obtained.

### Measurement of IR Peak of Surface of Image Layer of DTF Sheet on Decorative Layer Side

The measurement of the IR peak of the surface of the image layer on the decorative layer side was also performed through the same procedure as that of the measurement of the IR peak of the surface of the image layer on the hot melt adhesive layer side. Specifically, by etching the DTF sheet in the above-described procedure using TOF-SIMS, a surface region of the image layer on the decorative layer side was dug out. Next, an IR peak of the surface of the image layer on the decorative layer side that was dug out by etching was measured. Etching conditions and measurement conditions of the IR peak were as described above, and the etching was performed from the hot melt adhesive layer side.

A peak maximum value at 1640 to 1780 cm⁻¹ derived from C═O of an ester group (a straight line connecting an absorbance at 1640 cm⁻¹ and an absorbance at 1780 cm⁻¹ is assumed as a baseline) is represented by X₂₁, a peak maximum value at 800 to 830 cm⁻¹ derived from a carbon double bond C═C (a straight line connecting an absorbance at 800 cm⁻¹ and an absorbance at 830 cm⁻¹ is assumed as a baseline) is represented by Y₂₁, and By introducing each of the numerical values into Expression (Y2), the normalized carbon double bond peak intensity Z₂₁ was obtained.

### Intensity Ratio P₂

The numerical values of the normalized carbon double bond peak intensity Z₂₁ of the surface of the image layer of the DTF sheet on the decorative layer side and the normalized carbon double bond peak intensity Z₂₂ of the surface of the image layer of the DTF sheet on the hot melt adhesive layer side were introduced into Expression (Y1) to obtain the intensity ratio P₂.

### Evaluation

### Blocking Resistance

The DTF sheet was cut to prepare two test pieces. The size of each of the test pieces was 5 cm×4 cm. The two test pieces were laminated to obtain a laminate such that a surface one test piece A on the hot melt adhesive layer side and a temporary support surface of the other test piece B were in contact with each other. The laminate was interposed between one set of stainless steel plates larger than the laminate. By placing a weight on the stainless steel plates, the weight was adjusted to 0.03 MPa. The laminate on which the weight was placed was left to stand in a constant temperature machine at 60° C. for 24 hours. After 24 hours, the laminate was taken out from the constant temperature machine, and when the two test pieces were separated from the laminate, whether or not image chipping occurs in the test piece A was evaluated by visual inspection.
A: image chipping was not observed in the test piece A.
D: image chipping was observed in the test piece A.

### Friction Resistance

As a method of evaluating friction resistance and texture in a case where a thermal transfer sheet was transferred to fabric, the transfer sheet was transferred to the fabric substrate in the following procedure, and the residual carbon double bond was polymerized by light irradiation to improve the film hardness, and the friction resistance was evaluated.

### Transfer to Fabric Substrate

Cotton fabric was prepared, the fabric and the thermal transfer sheet were laminated such that the fabric and the surface of the thermal transfer sheet on the hot melt adhesive layer side were in contact with each other, and the laminate was thermally compressed by a heat press machine at 150° C. for 30 seconds. Next, the temporary support and the gold foil in a portion where the image layer was not formed were peeled off to obtain a transferred material.

### Light Irradiation

The transferred material was irradiated with ultraviolet rays using an UV exposure machine (LED-UV lamp, wavelength: 385 nm) in a low-oxygen atmosphere (oxygen concentration: 1,000 volume ppm or less) at an exposure amount of 1000 mJ/cm². As a result, the residual carbon double bond of the image layer was polymerized to improve the friction resistance of the transferred material.

### Friction Resistance Evaluation

Regarding the transferred material, a rubbing test was performed based on ISO 105 X12:2001 (wet) to evaluate friction resistance based on the area in which the decorative layer was peeled off.
A: the peeling of the decorative layer was less than 5%.
B: the peeling of the decorative layer was 5% or more and less than 10%
C: the peeling of the decorative layer was 10% or more and less than 15%
D: the peeling of the decorative layer was 15% or more.

### Texture of Transferred Material

The transferred material obtained as described above was cut into 10 cm×4 cm (hereinafter, also referred to as a sample for evaluation). White fabric having the same size as described above to which the DTF sheet was not bonded was prepared as a reference white fabric sample.

As a jig for evaluation, a stainless steel plate having a length (long side) of 200 mm, a width (short side) of 100 mm, and a thickness of 1 mm was prepared.

The jig for evaluation stood such that a short side direction was a vertical direction and a long side direction was a horizontal direction.

Next, a center portion (that is, a center line) of the sample for evaluation in the longitudinal direction was placed on the long side of the jig for evaluation facing in the horizontal direction, and both sides (both end part sides) of the sample for evaluation in the longitudinal direction were hung. In this state, a direct distance between one end part in the longitudinal direction and the other end part in the longitudinal direction of the sample for evaluation was measured and obtained as a deflection distance.

Regarding the reference white fabric sample, the deflection distance was measured as described above.

Regarding a Δdeflection distance as a difference between the deflection distance of the sample for evaluation and the reference white fabric sample, texture flexibility of a printed material was evaluated based on the following evaluation standards.
A: the Δdeflection distance was less than 20 mm.
B: the Δdeflection distance was 20 mm or more and less than 40 mm.
C: the Δdeflection distance was 40 mm or more and less than 60 mm.
D: the Δdeflection distance was 60 mm or more.

### Peelability of Image Border

An image border of the transferred material obtained as described above was observed to evaluate whether or not border chipping occurred.
A: chipping was not observed in the image border.
B: chipping was observed in the image border.

### Comparative Example 1

A DTF sheet was prepared using the same method as that of Example 1, except that the image layer was formed of a material shown in Table 4 described below, and the same evaluation as that of Example 1 was performed.

### Comparative Example 2

A DTF sheet was prepared using the same method as that of Example 1, except that the image layer curing step was not performed, and the same evaluation as that of Example 1 was performed.

### Comparative Example 3

A DTF sheet was prepared using the same method as that of Example 1, except that the irradiation conditions of ultraviolet rays in the image layer curing step were changed to an exposure amount of 300 mJ/cm², and the same evaluation as that of Example 1 was performed. The intensity ratio P₁ was 0.400.

### Comparative Example 4

A DTF sheet was prepared using the same method as that of Example 1, except that the irradiation conditions of ultraviolet rays in the image layer curing step were changed to a low-oxygen atmosphere (oxygen concentration: 1,000 ppm or less) and an exposure amount of 1000 mJ/cm², and the same evaluation as that of Example 1 was performed. The intensity ratio P₁ was 0.002.

### Comparative Example 5

A DTF sheet was prepared using the same method as that of Example 1, except that the step order was changed as shown in Table 4 described below, and the same evaluation as that of Example 1 was performed. The hot melt powder was not attached to the image layer, and adhesiveness was not present. Therefore, the transfer to the fabric was not able to be performed.

### Comparative Example 6

A DTF sheet was prepared using the same method as that of Example 1, except that the preparation of the ink and the method of forming the image were changed to adopt a procedure and a material shown below, and the same evaluation as that of Example 1 was performed. Since the ink did not include the (meth)acrylate compound, a peak derived from the carbon double bond C═C was not detected. In addition, the transfer was able to be performed, but the friction resistance was evaluated as “D”.

### Preparation of Ink

Components shown in Table 4 described below were mixed to prepare an ink for forming the image layer (ink for the image layer).
APD1000 Black (manufactured by Fujifilm Imaging Colorants Ltd.) (pigment dispersion liquid)
SUPERFLEX 470 (polyurethane latex aqueous solution, manufactured by DKS Co., Ltd.)
SURFYNOL 440 (surfactant, manufactured by Nissin Chemical Co., Ltd.)
Glycerin (organic solvent, manufactured by FUJIFILM Wako Pure Chemical Corporation)

### Method of Forming Image

As an ink jet recording device, a device on which an ink jet head (product name “StarFire SG-1024SA”, manufactured by FUJIFILM Dimatix, Inc.) and an ink circulation pump were mounted was prepared.

As a temporary support, a PET film (COSMOSHINE A4100, manufactured by Toyobo Co., Ltd., thickness: 50 μm) with an easy adhesion layer on one side was prepared. A gold foil sheet was laminated on a surface (that is, on a PET film surface) of the temporary support where the easy adhesion layer was not provided, and this laminate was set as a recording medium.

An ink tank connected to the ink jet head was filled with the ink for the image layer.

The ink jet head was disposed in a line shape such that nozzles were arranged in a direction orthogonal to a movement direction of a stage.

As ink jetting conditions, the amount of ink droplets jetted was 49.5 pL, a jetting frequency was 10 kHz, a resolution was 400 dpi×400 dpi, and the amount of ink applied per fabric area was 12.3 g/m².

The ink circulation pump was operated to circulate the ink between the ink tank and the ink jet head.

Under the above-described conditions, the ink was jetted to the recording medium to form the image layer.

### Examples 2 to 8, 17 to 19, and 22 to 24

DTF sheets were prepared using the same method as that of Example 1, except that the formulation and the materials were changed as shown in Table 4 described below, and the same evaluation as that of Example 1 was performed.

### Example 9

### Preparation of Synthetic Urethane Acrylate Compound 1

333.3 g of polycarbonate diol (product name “DURANOL (registered trademark) T5651”, manufactured by Asahi Kasei Corporation), 148.2 g of isophorone diisocyanate (IPDI), and 77.4 g of methyl ethyl ketone were charged into a three-neck flask, and were heated to 50° C.

In DURANOL (registered trademark) T5651, Rc¹ and Rc² in the following compound (2-18) PC each independently represent an alkylene group having 5 or 6 carbon atoms, and Mn is 1000.

0.500 g of an inorganic bismuth catalyst (product name “NEOSTANN U-600”, manufactured by NITTO KASEI CO., LTD.) was diluted with 2.00 g of methyl ethyl ketone, the diluted liquid was added to the solution, and the solution was stirred at 60° C. for 3 hours. Further, 77.4 g of 2-hydroxyethyl acrylate was added, and the solution was stirred at 80° C. for 5 hours. Next, methyl ethyl ketone was removed under reduced pressure, and a synthetic urethane acrylate compound 1 was obtained.

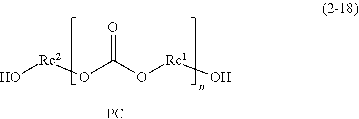

DTF sheets were prepared using the same method as that of Example 1, except that the synthetic urethane acrylate compound 1 was used and the formulation and the materials were changed as shown in Table 4 described below, and the same evaluation as that of Example 1 was performed.

### Examples 10 to 12

### Preparation of Synthetic Urethane Acrylate Compounds 2 to 4

Synthetic urethane acrylate compounds 2 to 4 were prepared according to the synthesis procedure of the synthetic urethane acrylate compound 1 according to Example 9, except that the composition and the materials were changed to a composition shown in Table 2 below.

### Preparation of Transfer Sheet

DTF sheets were prepared using the same method as that of Example 9, except that the formulation and the materials were changed as shown in Table 4 described below, and the same evaluation as that of Example 1 was performed.

Hereinafter, Table 2 below shows compositions of monomer components forming the synthetic urethane acrylate compounds 1 to 4. The unit of the content of each of the components in Table 2 is “gram (g)”.

The details of the components shown in Table 2 will be shown.
Hexanediol (manufactured by Tokyo Chemical Industry Co., Ltd.)
HMDI (hexamethylene diisocyanate, manufactured by Tokyo Chemical Industry Co., Ltd.)

TABLE 2

| | Synthetic | Synthetic | Synthetic | Synthetic |
|---|---|---|---|---|
| | Urethane | Urethane | Urethane | Urethane |
| | Acrylate | Acrylate | Acrylate | Acrylate |
| | Compound 1 | Compound 2 | Compound 3 | Compound 4 |
| DURANOL | 333.3 | 333.3 | | |
| T5651 | | | | |
| Hexanediol | | | 39.4 | 39.4 |
| IPDI | 148.2 | | 148.2 | |
| HMDI | | 112.1 | | 112.1 |
| 2-Hydroxyethyl | 77.4 | 77.4 | 77.4 | 77.4 |
| Acrylate | | | | |

### Example 13

A DTF sheet was prepared using the same method as that of Example 1, except that a metallic ink and an undercoat ink were prepared in the following procedure to prepare a recording medium, and the same evaluation as that of Example 1 was performed.

### Preparation of Metallic Ink

Components were mixed to obtain a composition (the unit of the content in the table is “% by mass) shown in Table 3 below. The obtained mixture was stirred using a mixer (product name “L4R”, manufactured by Silverson Machines Ltd.) for 30 minutes under conditions of 4,000 rotations/min to prepare a metallic ink.

### Preparation of Undercoat Ink

Components were mixed to obtain a composition (the unit of the content in the table is “% by mass) shown in Table 3 below. The obtained mixture was stirred using a mixer (product name “L4R”, manufactured by Silverson Machines Ltd.) for 30 minutes under conditions of 4,000 rotations/min to prepare an undercoat ink.

TABLE 3

| | | Metallic | Undercoat |
|---|---|---|---|
| | Product Name (Manufacturer) | Ink | ink |
| Indium (In) Pigment Dispersion | Leaf Powder 49CJ-1150 (manufactured by OIKE & | 6 | |
| | Co., Ltd.) | | |
| Dipropylene Glycol Diacrylate (DPGDA) | DPGDA (manufactured by Arkema S.A.) | 20.97 | |
| 1,6-Hexanediol Dicrylate (HDDA) | SR238NS (manufactured by Arkema S.A.) | 29.75 | |
| Polyethylene Glycol 400 Diacrylate (PEG(400)DA) | SR344 (manufactured by Arkema S.A.) | 9.28 | |
| Neopentyl Glycol Propoxylated Diacrylate (NPGPODA) | SR9003NS (manufactured by Arkema S.A.) | | 25 |
| N-Vinylcaprolactam (NVC) | NVC (manufactured by BASF SE) | | 30 |
| Cyclic Trimethylol-propane Formal Acrylate (CTFA) | SR531 (manufactured by Arkema S.A.) | 20 | |
| Cyclic Trimethylol-propane Formal Acrylate (CTFA) | VISCOAT #200 (manufactured by OSAKA | | 38.4 |
| | ORGANIC CHEMICAL INDUSTRY LTD.) | | |
| 2,2,2-Trifluoroethyl acrylate | VISCOAT 3F (manufactured by OSAKA | 2.5 | |
| | ORGANIC CHEMICAL INDUSTRY LTD.) | | |
| Tris(N-Nitroso-N-Phenylhydroxylamine) Aluminum Salt | FLORSTAB UV-12 (manufactured by Kromachem | | 0.5 |
| (UV12) | Ltd.) | | |
| 13 to 15% Quinone Derivative, 85 to 87% GPTA | Irgastab UV 22 (manufactured by BASF SE) | 1.5 | |
| (propxylated glycerol triacrylate) mixture (UV22) | | | |
| 4-Methoxyphenol (MQ) | 4-Methoxyphenol (manufactured by FUJIFILM | 0.5 | |
| | Wako Pure Chemical Corporation) | | |
| Hydroxy-TEMPO (OH-TEMPO) | Hydroxy-TEMPO (manufactured by FUJIFILM | 0.5 | |
| | Wako Pure Chemical Corporation) | | |
| Bis(2,4,6-trimethylbenzoyl)phenylphosphine Oxide(BAPO) | Omnirad 819 (manufactured by IGM Resins B.V.) | 4 | 2.8 |
| 2,4,6-Trimethylbenzoyldiphenylphosphine Oxide (TPO) | Speedcure TPO (manufactured by Arkema S.A.) | 4 | 2.8 |
| 2-Isopropylthioxanthone (ITX) | Speedcure 2-ITX (manufactured by Arkema S.A.) | 1 | 0.5 |

### Preparation of Recording Medium

As a temporary support, a PET film (COSMOSHINE A4100, manufactured by Toyobo Co., Ltd., thickness: 50 in) with an easy adhesion layer on one side was prepared. The temporary support was set in a desktop ink jet printer (UJF-7151 plus, manufactured by MIMAKI ENGINEERING CO., LTD.) on which a LED light source was mounted such that a surface (that is, a PET film surface) of the temporary support where the easy adhesion layer was not provided was a printing surface. Among printing conditions mounted on the same machine, a Fine 600×900 VD Si gloss mode (20 passes) was used, and the adjusted undercoat ink was printed on the temporary support. Next, the metallic ink was printed on the printed portion of the undercoat ink in the Fine 600×900 VD Si gloss mode (20 passes) to prepare a recording medium where the metallic image layer was the decorative layer.

### Example 14

A DTF sheet was prepared using the same method as that of Example 1, except that a cholesteric liquid crystal layer ink was prepared in the following procedure to prepare a recording medium, and the same evaluation as that of Example 1 was performed.

### Preparation of Cholesteric Liquid Crystal Layer Ink

### Ink Rm1

The following components were heated, completely dissolved, and mixed with each other to prepare an ink Rm1. Aviscosity (25° C.) of the ink Rm1 was 10.3 mPa·s, and a surface tension (25° C.) was 28 mN/m.
Diethylene glycol diethyl ether 61.97 parts by mass
Mixture of Polymerizable liquid crystal compounds (mixture of a compound (10), a compound (11), and a compound (12) described below) 35 parts by mass
FTERGENT 208G (manufactured by NEOS Co., Ltd.) 0.03 parts by mass
1-[4-(2-hydroxyethoxy)-phenyl]-2-hydroxy-methylpropanone (“Omnirad 819, manufactured by IGM Resins B. V”) 1.5 part by mass
Chiral compound A 1.5 parts by mass

The mixture of polymerizable liquid crystal compounds consists of 34% by mass of the compound (10), 33% by mass of the compound (11), and 33% by mass of the compound (12).

All of the compound (10), the compound (11), and the compound (12) are rod-like liquid crystal compounds.

Structures the compound (10), the compound (11), the compound (12), and the chiral compound A are as follows.

### Compound (10), Compound (11), and Compound (12)

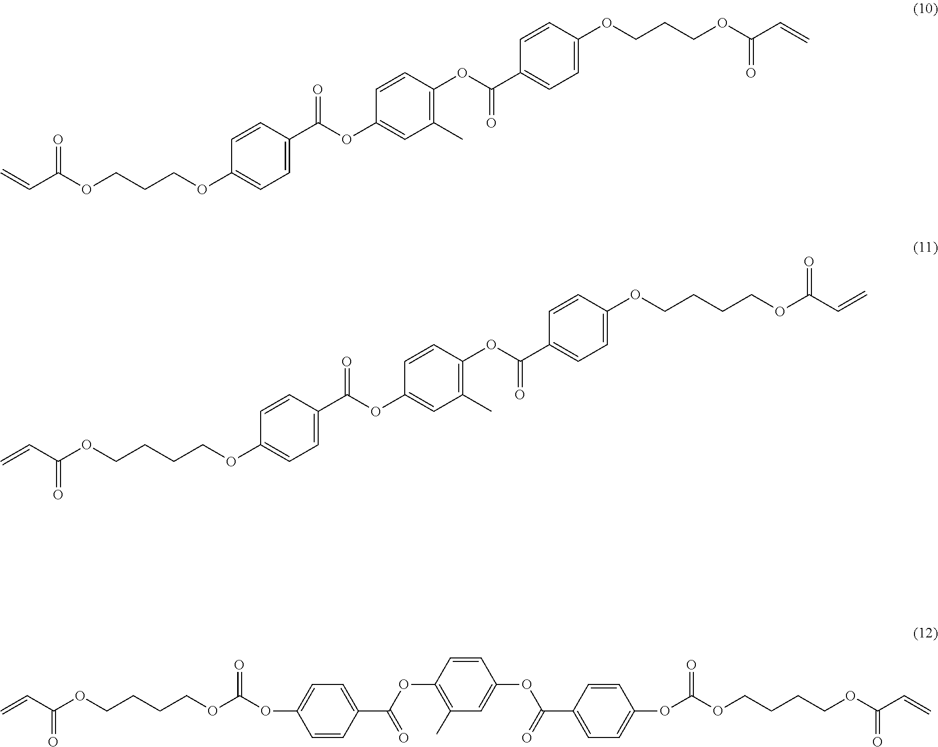

### Chiral Compound A

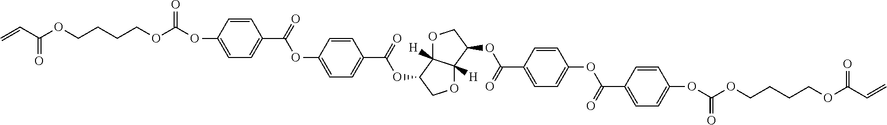 [SMILES: C=CC(=O)OCCCCOC(=O)Oc1ccc(C(=O)Oc2ccc(C(=O)O[C@H]3CO[C@@H]4[C@H]3OC[C@H]4OC(=O)c3ccc(OC(=O)c4ccc(OC(=O)OCCCCOC(=O)C=C)cc4)cc3)cc2)cc1]

### Preparation of Recording Medium

As the temporary support, FE2000 (product name “polyester film”, manufactured by FUTAMURA CHEMICAL CO., LTD.) was prepared.

This support was heated to 55° C., and the ink Rm1 was applied using an ink jet method. After the printing, the substrate was heated at 70° C. for 5 minutes, and the applied ink was exposed to ultraviolet rays to record a cholesteric liquid crystal image layer. As a result, a recording medium where the cholesteric liquid crystal layer was the decorative layer was obtained.

During the preparation of the image recorded material, the application of the ink was performed using a multi-pass ink jet recording device “UJF3042HG” (manufactured by MIMAKI ENGINEERING CO., LTD.) under conditions of a resolution of 720 dpi×600 dpi and a recording speed of 32 passes, and the exposure was performed using CSOT-40E (metal halide light source, manufactured by GS Yuasa International Ltd.).

### Example 15

A DTF sheet was prepared using the same method as that of Example 1, except that residual powder was not removed after spraying the hot melt powder, and the same evaluation as that of Example 1 was performed.

### Example 16

A DTF sheet was prepared using the same method as that of Example 1, except that the amount of the hot melt powder sprayed was 10 g/m², and the same evaluation as that of Example 1 was performed.

### Example 20

A DTF sheet was prepared using the same method as that of Example 1, except that the irradiation conditions of ultraviolet rays in the image layer curing step were changed to an exposure amount of 280 mJ/cm², and the same evaluation as that of Example 1 was performed. The intensity ratio P₁ was 0.295.

### Example 21

A DTF sheet was prepared using the same method as that of Example 1, except that the irradiation conditions of ultraviolet rays in the image layer curing step were changed to an exposure amount of 2500 mJ/cm², and the same evaluation as that of Example 1 was performed. The intensity ratio P₁ was 0.006.

### Details of Various Components Shown in Table 4

Hereinafter, various components shown in Table 4 will be described. The description of the components described above will not be repeated.
UV-6630B: a bifunctional urethane (meth)acrylate compound (manufactured by Mitsubishi Chemical Group Corporation)
CN996: a bifunctional urethane (meth)acrylate compound (manufactured by Arkema S.A.)
VISCOAT #230: a bifunctional (meth)acrylate compound (hexanediol diacrylate, manufactured by OSAKA ORGANIC CHEMICAL INDUSTRY LTD.)
VISCOAT #540: a bifunctional (meth)acrylate compound (bisphenol A epoxy (meth)acrylate, manufactured by OSAKA ORGANIC CHEMICAL INDUSTRY LTD.)
CN1074 NS: a bifunctional (meth)acrylate compound (polyester (meth)acrylate, manufactured by Arkema S.A.)
G4316: “GENOMER 4316” (trifunctional urethane (meth)acrylate compound), manufactured by Rahn AG
UV-7600B: a hexafunctional urethane (meth)acrylate compound (manufactured by Mitsubishi Chemical Group Corporation)
BR-113: “DIANAL (registered trademark) BR-113” (polymethyl methacrylate), manufactured by Mitsubishi Chemical Group Corporation
Pigment Mill Base Black, Pigment Mill Base Cyan, Pigment Mill Base Magenta, Pigment Mill Base Yellow: those prepared as described above were used.

Hereinafter, Table 4 is shown.

The numerical value of the mixing amount of each of the components in Table 4 is represented by “part(s) by mass”.

“Total % by Mass of Monofunctional and Bifunctional Compounds” in Table 4 represent the total content (% by mass) of monofunctional (meth)acrylate compounds and bifunctional (meth)acrylate compounds with respect to the solid content of the composition.

In addition, “Area Ratio of Hot melt adhesive layer” in Table 4 represents the ratio (%) of the area of the hot melt adhesive layer to the area of the image layer in a plan view of the transfer sheet.

The weight-average molecular weight of the acrylate resin and the methacrylate resin in the image layer of the DTF sheet according to each of Examples was 200,000 to 500,000.

TABLE 4

| | | | | | Compar- | Compar- | Compar- | Compar- |
|---|---|---|---|---|---|---|---|---|
| | | | Solid Content | | ative | ative | ative | ative |
| | | | Concentration | Exam- | Exam- | Exam- | Exam- | Exam- |
| Table 4 (First) | | | in Material | ple 1 | ple 1 | ple 2 | ple 3 | ple 4 |
| Acrylic Image | (Meth)Acrylate | GENOMER 4215 | 100% | 20 | | 20 | 20 | 20 |
| Layer Ink | Compound | (Urethane Bifunctional) | | | | | | |
| Formulation | | UV-6630B | 100% | | | | | |
| | | CN996 (Urethane | 100% | | | | | |
| | | Bifunctional) | | | | | | |
| | | VISCOAT #230 | 100% | | | | | |
| | | VISCOAT #540 | 100% | | | | | |
| | | CN1074NS | 100% | | | | | |
| | | G4316 | 100% | | | | | |
| | | UV-7600B | 100% | | | | | |
| | | Synthetic Urethane | 100% | | | | | |
| | | Acrylate Compound 1 | | | | | | |
| | | Synthetic Urethane | 100% | | | | | |
| | | Acrylate Compound 2 | | | | | | |
| | | Synthetic Urethane | 100% | | | | | |
| | | Acrylate Compound 3 | | | | | | |
| | | Synthetic Urethane | 100% | | | | | |
| | | Acrylate Compound 4 | | | | | | |
| | Pigment | Pigment Mill Base Black | 40% | 5 | 5 | 5 | 5 | 5 |
| | | Pigment Mill Base Cyan | 40% | | | | | |
| | | Pigment Mill Base Magenta | 45% | | | | | |
| | | Pigment Mill Base Yellow | 40% | | | | | |
| | | APD1000 Black | 14% | | | | | |
| | Acrylic Polymer | BR-113 (Zero-Functional) | 100% | | 20 | | | |
| | Urethane Polymer | SUPERFLEX 470 | 38% | | | | | |
| | Polymerization | IRGACURE819 | 100% | 2 | 2 | 2 | 2 | 2 |
| | Initiator | | | | | | | |
| | Polymerization | IRGACURE2959 | 100% | 1 | 1 | 1 | 1 | 1 |
| | Initiator | | | | | | | |
| | Surfactant | BYK331 | 100% | 0.1 | 0.1 | 0.1 | 0.1 | 0.1 |
| | Surfactant | SURFYNOL 440 | 100% | | | | | |
| | Organic Solvent | Diethylene Glycol | 0% | 71.9 | 71.9 | 71.9 | 71.9 | 71.9 |
| | | Diethyl Ether | | | | | | |
| | Organic Solvent | Glycerin | 0% | | | | | |
| | | Ultrapure Water | 0% | | | | | |

| Intensity Ratio P₁ | | — | 0.280 | — | 1.000 | 0.400 | 0.002 |
|---|---|---|---|---|---|---|---|
| Intensity Ratio P₂ | | — | 46.7 | — | 1.000 | 66.7 | 1.111 |
| Total % by Mass of Monofunctional and Bifunctional Compounds | | — | 80% | 0% | 80% | 80% | 80% |
| Step Order ([A] Coating Film Formation → [B] Hot Melt Adhesive | | — | A→B→C | A→B→C | A→B | A→B→C | A→B→C |
| Layer Formation → [C] Image Layer Formation by Curing | | | | | | | |
| Kind of Decorative Layer | | — | X | X | X | X | X |
| (X: Metal Foil, Y: Metallic Ink, Z: Cholesteric Liquid Crystal Layer) | | | | | | | |
| Kind of Hot Melt Adhesive | | — | X | X | X | X | X |
| (X: Hot Melt Powder, Y: Polyurethane Aqueous Dispersion) | | | | | | | |
| Area Ratio of Hot Melt Adhesive Layer | | — | 70% | 70% | 70% | 70% | 70% |
| Evaluation | Blocking Resistance | — | A | A | D | D | A |
| | Friction Resistance of Transferred Material | — | A | D | A | A | D |
| | Texture of Transferred Material | — | A | A | A | A | A |
| | Peelability of Image Border | — | A | A | B | B | B |

TABLE 5

| | | | | Compar- | Compar- | | | |
|---|---|---|---|---|---|---|---|---|
| | | | Solid Content | ative | ative | | | |
| | | | Concentration | Exam- | Exam- | Exam- | Exam- | Exam- |
| Table 4 (Second) | | | in Material | ple 5 | ple 6 | ple 2 | ple 3 | ple 4 |
| Acrylic Image | (Meth)Acrylate | GENOMER 4215 | 100% | 20 | | 20 | 10 | 10 |
| Layer Ink | Compound | (Urethane Bifunctional) | | | | | | |
| Formulation | | UV-6630B | 100% | | | | | |
| | | CN996 (Urethane | 100% | | | | | |
| | | Bifunctional) | | | | | | |
| | | VISCOAT #230 | 100% | | | | | |
| | | VISCOAT #540 | 100% | | | | | |
| | | CN1074NS | 100% | | | | | |
| | | G4316 | 100% | | | | | 10 |
| | | UV-7600B | 100% | | | | 10 | |
| | | Synthetic Urethane | 100% | | | | | |
| | | Acrylate Compound 1 | | | | | | |
| | | Synthetic Urethane | 100% | | | | | |
| | | Acrylate Compound 2 | | | | | | |
| | | Synthetic Urethane | 100% | | | | | |
| | | Acrylate Compound 3 | | | | | | |
| | | Synthetic Urethane | 100% | | | | | |
| | | Acrylate Compound 4 | | | | | | |
| | Pigment | Pigment Mill Base Black | 40% | 5 | | 5 | 5 | 5 |
| | | Pigment Mill Base Cyan | 40% | | | | | |
| | | Pigment Mill Base Magenta | 45% | | | | | |
| | | Pigment Mill Base Yellow | 40% | | | | | |
| | | APD1000 Black | 14% | | 28.0 | | | |
| | Acrylic Polymer | BR-113 (Zero-Functional) | 100% | | | | | |
| | Urethane Polymer | SUPERFLEX 470 | 38% | | 19.7 | | | |
| | Polymerization | IRGACURE819 | 100% | 2 | | 2 | 2 | 2 |
| | Initiator | | | | | | | |
| | Polymerization | IRGACURE2959 | 100% | 1 | | 1 | 1 | 1 |
| | Initiator | | | | | | | |
| | Surfactant | BYK331 | 100% | 0.1 | | 0.1 | 0.1 | 0.1 |
| | Surfactant | SURFYNOL 440 | 100% | | 0.05 | | | |
| | Organic Solvent | Diethylene Glycol | 0% | 71.9 | | 71.9 | 71.9 | 71.9 |
| | | Diethyl Ether | | | | | | |
| | Organic Solvent | Glycerin | 0% | | 30.0 | | | |
| | | Ultrapure Water | 0% | | 22.2 | | | |

| Intensity Ratio P₁ | | — | 0.280 | — | 0.280 | 0.280 | 0.280 |
|---|---|---|---|---|---|---|---|
| Intensity Ratio P₂ | | — | 46.7 | — | 46.7 | 46.7 | 46.7 |
| Total % by Mass of Monofunctional and Bifunctional Compounds | | — | 80% | 0% | 80% | 40% | 40% |
| Step Order ([A] Coating Film Formation → [B] Hot Melt Adhesive | | — | A→C→B | A→B→C | A→B→C | A→B→C | A→B→C |
| Layer Formation → [C] Image Layer Formation by Curing | | | | | | | |
| Kind of Decorative Layer | | — | X | X | X | X | X |
| (X: Metal Foil, Y: Metallic Ink, Z: Cholesteric Liquid Crystal Layer) | | | | | | | |
| Kind of Hot Melt Adhesive | | — | X | X | Y | X | X |
| (X: Hot Melt Powder, Y: Polyurethane Aqueous Dispersion) | | | | | | | |
| Area Ratio of Hot Melt Adhesive Layer | | — | Preparation | 70% | 98% | 70% | 70% |
| | | | NG (0%) | | | | |
| Evaluation | Blocking Resistance | — | A | A | A | A | A |
| | Friction Resistance of Transferred Material | — | Transfer NG | D | B | A | A |
| | Texture of Transferred Material | — | Transfer NG | A | A | D | D |
| | Peelability of Image Border | — | Transfer NG | B | A | A | A |

TABLE 6

| | | | Solid Content | | | | | |
|---|---|---|---|---|---|---|---|---|
| | | | Concentration | Exam- | Exam- | Exam- | Exam- | Exam- |
| Table 4 (Third) | | | in Material | ple 5 | ple 6 | ple 7 | ple 8 | ple 9 |
| Acrylic Image | (Meth) Acrylate | GENOMER 4215 | 100% | 12.5 | | | | |
| Layer Ink | Compound | (Urethane Bifunctional) | | | | | | |
| Formulation | | UV-6630B | 100% | | | | | |
| | | CN996 (Urethane | 100% | | | | | |
| | | Bifunctional) | | | | | | |
| | | VISCOAT #230 | 100% | | 20 | | | |
| | | VISCOAT #540 | 100% | | | 20 | | |
| | | CN1074NS | 100% | | | | 20 | |
| | | G4316 | 100% | 7.5 | | | | |
| | | UV-7600B | 100% | | | | | |
| | | Synthetic Urethane | 100% | | | | | 20 |
| | | Acrylate Compound 1 | | | | | | |
| | | Synthetic Urethane | 100% | | | | | |
| | | Acrylate Compound 2 | | | | | | |
| | | Synthetic Urethane | 100% | | | | | |
| | | Acrylate Compound 3 | | | | | | |
| | | Synthetic Urethane | 100% | | | | | |
| | | Acrylate Compound 4 | | | | | | |
| | Pigment | Pigment Mill Base Black | 40% | 5 | 5 | 5 | 5 | 5 |
| | | Pigment Mill Base Cyan | 40% | | | | | |
| | | Pigment Mill Base Magenta | 45% | | | | | |
| | | Pigment Mill Base Yellow | 40% | | | | | |
| | | APD1000 Black | 14% | | | | | |
| | Acrylic Polymer | BR-113 (Zero-Functional) | 100% | | | | | |
| | Urethane Polymer | SUPERFLEX 470 | 38% | | | | | |
| | Polymerization | IRGACURE819 | 100% | 2 | 2 | 2 | 2 | 2 |
| | Initiator | | | | | | | |
| | Polymerization | IRGACURE2959 | 100% | 1 | 1 | 1 | 1 | 1 |
| | Initiator | | | | | | | |
| | Surfactant | BYK331 | 100% | 0.1 | 0.1 | 0.1 | 0.1 | 0.1 |
| | Surfactant | SURFYNOL 440 | 100% | | | | | |
| | Organic Solvent | Diethylene Glycol | 0% | 71.9 | 71.9 | 71.9 | 71.9 | 71.9 |
| | | Diethyl Ether | | | | | | |
| | Organic Solvent | Glycerin | 0% | | | | | |
| | | Ultrapure Water | 0% | | | | | |

| Intensity Ratio P₁ | | — | 0.280 | 0.280 | 0.280 | 0.280 | 0.280 |
|---|---|---|---|---|---|---|---|
| Intensity Ratio P₂ | | — | 46.7 | 46.7 | 46.7 | 46.7 | 46.7 |
| Total % by Mass of Monofunctional and Bifunctional Compounds | | — | 50% | 80% | 80% | 80% | 80% |
| Step Order ([A] Coating Film Formation → [B] Hot Melt Adhesive | | — | A→B→C | A→B→C | A→B→C | A→B→C | A→B→C |
| Layer Formation → [C] Image Layer Formation by Curing | | | | | | | |
| Kind of Decorative Layer | | — | X | X | X | X | X |
| (X: Metal Foil, Y: Metallic Ink, Z: Cholesteric Liquid Crystal Layer) | | | | | | | |
| Kind of Hot Melt Adhesive | | — | X | X | X | X | X |
| (X: Hot Melt Powder, Y: Polyurethane Aqueous Dispersion) | | | | | | | |
| Area Ratio of Hot Melt Adhesive Layer | | — | 70% | 70% | 70% | 70% | 70% |
| Evaluation | Blocking Resistance | — | A | A | A | A | A |
| | Friction Resistance of Transferred Material | — | A | A | A | C | B |
| | Texture of Transferred Material | — | A | C | C | A | B |
| | Peelability of Image Border | — | A | A | A | A | A |

TABLE 7

| | | | Solid Content | | | | | |
|---|---|---|---|---|---|---|---|---|
| | | | Concentration | Exam- | Exam- | Exam- | Exam- | Exam- |
| Table 4 (Fourth) | | | in Material | ple 10 | ple 11 | ple 12 | ple 13 | ple 14 |
| Acrylic Image | (Meth)Acrylate | GENOMER 4215 | 100% | | | | 20 | 20 |
| Layer Ink | Compound | (Urethane Bifunctional) | | | | | | |
| Formulation | | UV-6630B | 100% | | | | | |
| | | CN996 (Urethane | 100% | | | | | |
| | | Bifunctional) | | | | | | |
| | | VISCOAT #230 | 100% | | | | | |
| | | VISCOAT #540 | 100% | | | | | |
| | | CN1074NS | 100% | | | | | |
| | | G4316 | 100% | | | | | |
| | | UV-7600B | 100% | | | | | |
| | | Synthetic Urethane | 100% | | | | | |
| | | Acrylate Compound 1 | | | | | | |
| | | Synthetic Urethane | 100% | 20 | | | | |
| | | Acrylate Compound 2 | | | | | | |
| | | Synthetic Urethane | 100% | | 20 | | | |
| | | Acrylate Compound 3 | | | | | | |
| | | Synthetic Urethane | 100% | | | 20 | | |
| | | Acrylate Compound 4 | | | | | | |
| | Pigment | Pigment Mill Base Black | 40% | 5 | 5 | 5 | 5 | 5 |
| | | Pigment Mill Base Cyan | 40% | | | | | |
| | | Pigment Mill Base Magenta | 45% | | | | | |
| | | Pigment Mill Base Yellow | 40% | | | | | |
| | | APD1000 Black | 14% | | | | | |
| | Acrylic Polymer | BR-113 (Zero-Functional) | 100% | | | | | |
| | Urethane Polymer | SUPERFLEX 470 | 38% | | | | | |
| | Polymerization | IRGACURE819 | 100% | 2 | 2 | 2 | 2 | 2 |
| | Initiator | | | | | | | |
| | Polymerization | IRGACURE2959 | 100% | 1 | 1 | 1 | 1 | 1 |
| | Initiator | | | | | | | |
| | Surfactant | BYK331 | 100% | 0.1 | 0.1 | 0.1 | 0.1 | 0.1 |
| | Surfactant | SURFYNOL 440 | 100% | | | | | |
| | Organic Solvent | Diethylene Glycol | 0% | 71.9 | 71.9 | 71.9 | 71.9 | 71.9 |
| | | Diethyl Ether | | | | | | |
| | Organic Solvent | Glycerin | 0% | | | | | |
| | | Ultrapure Water | 0% | | | | | |

| Intensity Ratio P₁ | | — | 0.280 | 0.280 | 0.280 | 0.280 | 0.280 |
|---|---|---|---|---|---|---|---|
| Intensity Ratio P₂ | | — | 46.7 | 46.7 | 46.7 | 46.7 | 46.7 |
| Total % by Mass of Monofunctional and Bifunctional Compounds | | — | 80% | 80% | 80% | 80% | 80% |
| Step Order ([A] Coating Film Formation → [B] Hot Melt Adhesive | | — | A→B→C | A→B→C | A→B→C | A→B→C | A→B→C |
| Layer Formation → [C] Image Layer Formation by Curing | | | | | | | |
| Kind of Decorative Layer | | — | X | X | X | Y | Z |
| (X: Metal Foil, Y: Metallic Ink, Z: Cholesteric Liquid Crystal Layer) | | | | | | | |
| Kind of Hot Melt Adhesive | | — | X | X | X | X | X |
| (X: Hot Melt Powder, Y: Polyurethane Aqueous Dispersion) | | | | | | | |
| Area Ratio of Hot Melt Adhesive Layer | | — | 70% | 70% | 70% | 70% | 70% |
| Evaluation | Blocking Resistance | — | A | A | A | A | A |
| | Friction Resistance of Transferred Material | — | B | B | A | A | A |
| | Texture of Transferred Material | — | A | A | A | A | A |
| | Peelability of Image Border | — | A | A | A | A | A |

TABLE 8

| | | | Solid Content | | | | | |
|---|---|---|---|---|---|---|---|---|
| | | | Concentration | Exam- | Exam- | Exam- | Exam- | Exam- |
| Table 4 (Fifth) | | | in Material | ple 15 | ple 16 | ple 17 | ple 18 | ple 19 |
| Acrylic Image | (Meth)Acrylate | GENOMER 4215 | 100% | 20 | 20 | | | 20 |
| Layer Ink | Compound | (Urethane Bifunctional) | | | | | | |
| Formulation | | UV-6630B | 100% | | | 20 | | |
| | | CN996 (Urethane | 100% | | | | 20 | |
| | | Bifunctional) | | | | | | |
| | | VISCOAT #230 | 100% | | | | | |
| | | VISCOAT #540 | 100% | | | | | |
| | | CN1074NS | 100% | | | | | |
| | | G4316 | 100% | | | | | |
| | | UV-7600B | 100% | | | | | |
| | | Synthetic Urethane | 100% | | | | | |
| | | Acrylate Compound 1 | | | | | | |
| | | Synthetic Urethane | 100% | | | | | |
| | | Acrylate Compound 2 | | | | | | |
| | | Synthetic Urethane | 100% | | | | | |
| | | Acrylate Compound 3 | | | | | | |
| | | Synthetic Urethane | 100% | | | | | |
| | | Acrylate Compound 4 | | | | | | |
| | Pigment | Pigment Mill Base Black | 40% | 5 | 5 | 5 | 5 | |
| | | Pigment Mill Base Cyan | 40% | | | | | |
| | | Pigment Mill Base Magenta | 45% | | | | | |
| | | Pigment Mill Base Yellow | 40% | | | | | |
| | | APD1000 Black | 14% | | | | | |
| | Acrylic Polymer | BR-113 (Zero-Functional) | 100% | | | | | |
| | Urethane Polymer | SUPERFLEX 470 | 38% | | | | | |
| | Polymerization | IRGACURE819 | 100% | 2 | 2 | 2 | 2 | 2 |
| | Initiator | | | | | | | |
| | Polymerization | IRGACURE2959 | 100% | 1 | 1 | 1 | 1 | 1 |
| | Initiator | | | | | | | |
| | Surfactant | BYK331 | 100% | 0.1 | 0.1 | 0.1 | 0.1 | 0.1 |
| | Surfactant | SURFYNOL 440 | 100% | | | | | |
| | Organic Solvent | Diethylene Glycol | 0% | 71.9 | 71.9 | 71.9 | 71.9 | 76.9 |
| | | Diethyl Ether | | | | | | |
| | Organic Solvent | Glycerin | 0% | | | | | |
| | | Ultrapure Water | 0% | | | | | |

| Intensity Ratio P₁ | | — | 0.280 | 0.280 | 0.280 | 0.280 | 0.280 |
|---|---|---|---|---|---|---|---|
| Intensity Ratio P₂ | | — | 46.7 | 46.7 | 46.7 | 46.7 | 46.7 |
| Total % by Mass of Monofunctional and Bifunctional Compounds | | — | 80% | 80% | 80% | 80% | 87% |
| Step Order ([A] Coating Film Formation → [B] Hot Melt Adhesive | | — | A→B→C | A→B→C | A→B→C | A→B→C | A→B→C |
| Layer Formation → [C] Image Layer Formation by Curing | | | | | | | |
| Kind of Decorative Layer | | — | X | X | X | X | X |
| (X: Metal Foil, Y: Metallic Ink, Z: Cholesteric Liquid Crystal Layer) | | | | | | | |
| Kind of Hot Melt Adhesive | | — | X | X | X | X | X |
| (X: Hot Melt Powder, Y: Polyurethane Aqueous Dispersion) | | | | | | | |
| Area Ratio of Hot Melt Adhesive Layer | | — | 120% | 40% | 70% | 70% | 95% |
| Evaluation | Blocking Resistance | — | A | A | A | A | A |
| | Friction Resistance of Transferred Material | — | A | B | A | A | A |
| | Texture of Transferred Material | — | A | A | A | A | A |
| | Peelability of Image Border | — | B | A | A | A | A |

TABLE 9

| | | | Solid Content | | | | | |
|---|---|---|---|---|---|---|---|---|
| | | | Concentration | Exam- | Exam- | Exam- | Exam- | Exam- |
| Table 4 (Sixth) | | | in Material | ple 20 | ple 21 | ple 22 | ple 23 | ple 24 |
| Acrylic Image | (Meth) Acrylate | GENOMER 4215 | 100% | 20 | 20 | 20 | 20 | 20 |
| Layer Ink | Compound | (Urethane Bifunctional) | | | | | | |
| Formulation | | UV-6630B | 100% | | | | | |
| | | CN996 (Urethane | 100% | | | | | |
| | | Bifunctional) | | | | | | |
| | | VISCOAT #230 | 100% | | | | | |
| | | VISCOAT #540 | 100% | | | | | |
| | | CN1074NS | 100% | | | | | |
| | | G4316 | 100% | | | | | |
| | | UV-7600B | 100% | | | | | |
| | | Synthetic Urethane | 100% | | | | | |
| | | Acrylate Compound 1 | | | | | | |
| | | Synthetic Urethane | 100% | | | | | |
| | | Acrylate Compound 2 | | | | | | |
| | | Synthetic Urethane | 100% | | | | | |
| | | Acrylate Compound 3 | | | | | | |
| | | Synthetic Urethane | 100% | | | | | |
| | | Acrylate Compound 4 | | | | | | |
| | Pigment | Pigment Mill Base Black | 40% | 5 | 5 | | | |
| | | Pigment Mill Base Cyan | 40% | | | 5 | | |
| | | Pigment Mill Base Magenta | 45% | | | | 5 | |
| | | Pigment Mill Base Yellow | 40% | | | | | 5 |
| | | APD1000 Black | 14% | | | | | |
| | Acrylic Polymer | BR-113 (Zero-Functional) | 100% | | | | | |
| | Urethane Polymer | SUPERFLEX 470 | 38% | | | | | |
| | Polymerization | IRGACURE819 | 100% | 2 | 2 | 2 | 2 | 2 |
| | Initiator | | | | | | | |
| | Polymerization | IRGACURE2959 | 100% | 1 | 1 | 1 | 1 | 1 |
| | Initiator | | | | | | | |
| | Surfactant | BYK331 | 100% | 0.1 | 0.1 | 0.1 | 0.1 | 0.1 |
| | Surfactant | SURFYNOL 440 | 100% | | | | | |
| | Organic Solvent | Diethylene Glycol | 0% | 71.9 | 71.9 | 71.9 | 71.9 | 71.9 |
| | | Diethyl Ether | | | | | | |
| | Organic Solvent | Glycerin | 0% | | | | | |
| | | Ultrapure Water | 0% | | | | | |

| Intensity Ratio P₁ | | — | 0.295 | 0.006 | 0.280 | 0.280 | 0.280 |
|---|---|---|---|---|---|---|---|
| Intensity Ratio P₂ | | — | 36.9 | 20.0 | 46.7 | 46.7 | 46.7 |
| Total % by Mass of Monofunctional and Bifunctional Compounds | | — | 80% | 80% | 80% | 79% | 80% |
| Step Order ([A] Coating Film Formation → [B] Hot Melt Adhesive | | — | A→B→C | A→B→C | A→B→C | A→B→C | A→B→C |
| Layer Formation → [C] Image Layer Formation by Curing | | | | | | | |
| Kind of Decorative Layer | | — | X | X | X | X | X |
| (X: Metal Foil, Y: Metallic Ink, Z: Cholesteric Liquid Crystal Layer) | | | | | | | |
| Kind of Hot Melt Adhesive | | — | X | X | X | X | X |
| (X: Hot Melt Powder, Y: Polyurethane Aqueous Dispersion) | | | | | | | |
| Area Ratio of Hot Melt Adhesive Layer | | — | 70% | 70% | 70% | 70% | 70% |
| Evaluation | Blocking Resistance | — | A | A | A | A | A |
| | Friction Resistance of Transferred Material | — | A | A | A | A | A |
| | Texture of Transferred Material | — | A | A | A | A | A |
| | Peelability of Image Border | — | A | A | A | A | A |

It is clear from the results of Table 1 that the transfer sheets obtained using the manufacturing methods according to Examples and the transfer sheets according to Examples had excellent blocking resistance and excellent friction resistance of a transferred material.

In addition, it was verified from the results of Example 1 and Example 2 that, in a case where the hot melt adhesive layer was formed of the powdered hot melt adhesive, the friction resistance of a transferred material was further improved.

In addition, it was verified from a comparison between Example 1 and Examples 3 to 5 that, in a case where the total content of the monofunctional (meth)acrylate compounds and the bifunctional (meth)acrylate compounds in the composition for forming the image layer with respect to the total solid content of the composition was 50% by mass or more, texture of a transferred material was further improved.

In addition, it was verified from a comparison between Example 1 and Examples 6 to 8 that, in a case where the composition for forming the image layer included the urethane (meth)acrylate compound, texture of a transferred material was further improved or friction resistance of a transferred material was further improved.

In addition, it was verified from a comparison between Example 1 and Examples 9 to 12 that, in a case where the composition for forming the image layer included the composition represented by Formula (1) and at least one (preferably both) of R₃ or R₄ in the formula represents a linear or branched alkylene group, texture of a transferred material was further improved or friction resistance of a transferred material was further improved.

In addition, it was verified from a comparison between Example 1 and Examples 15 to 16 that, in a case where the ratio of the area of the hot melt adhesive layer to the area of the image layer was 60% or more, friction resistance of a transferred material was further improved.

In addition, it was verified that, in a case where the ratio of the area of the hot melt adhesive layer to the area of the image layer was 100% or less, peelability of an image border of a transferred material was further improved.

### EXPLANATION OF REFERENCES

10: transfer sheet
12: temporary support
14: decorative layer
16: image layer
18: hot melt adhesive layer
20: transfer layer

What is claimed is:

1. A method for manufacturing a transfer sheet, the method comprising:
a step 1 of forming a decorative layer on a temporary support;
a step 2 of applying a composition including one or more kinds selected from the group consisting of an acrylate compound and a methacrylate compound to the decorative layer to form a coating film;
a step 3 of forming a hot melt adhesive layer on the coating film; and
a step 4 of curing the coating film to form an image layer including one or more kinds selected from the group consisting of an acrylate resin and a methacrylate resin,
wherein an intensity ratio P₁ obtained from Expression (X1) is 0.005 to 0.300,
$${P}_{1} = {Z}_{12} / {Z}_{11} , \qquad Expression ( X1 )$$
in Expression (X1), P₁ represents the intensity ratio,
Z₁₁ represents a normalized carbon double bond peak intensity of the coating film obtained from Expression (X2), and
Z₁₂ represents a normalized carbon double bond peak intensity of a surface of the image layer on the hot melt adhesive layer side obtained from Expression (X3),
$${Z}_{11} = {Y}_{11} / {X}_{11} , \qquad Expression ( X2 )$$
in Expression (X2), X₁₁ represents a peak intensity derived from C═O of an ester group obtained by infrared absorption spectroscopy of the coating film,
Y₁₁ represents a peak intensity derived from a carbon double bond C═C obtained by the infrared absorption spectroscopy of the coating film, and
Z₁₁ represents the normalized carbon double bond peak intensity,
$${Z}_{12} = {Y}_{12} / {X}_{12} , \qquad Expression ( X3 )$$
in Expression (X3), X₁₂ represents a peak intensity derived from C═O of an ester group obtained by infrared absorption spectroscopy of the surface of the image layer on the hot melt adhesive layer side,
Y₁₂ represents a peak intensity derived from a carbon double bond C═C obtained by the infrared absorption spectroscopy of the surface of the image layer on the hot melt adhesive layer side, and
Z₁₂ represents the normalized carbon double bond peak intensity.

2. The method for manufacturing a transfer sheet according to claim 1,
wherein in the step 2, the coating film is formed on at least a part of the decorative layer, and
the step 3 is a step of spraying a powdered hot melt adhesive from the coating film side, removing the hot melt adhesive from a portion other than the coating film, and forming the hot melt adhesive layer on the coating film.

3. The method for manufacturing a transfer sheet according to claim 1,
wherein the composition includes one or more kinds selected from the group consisting of a monofunctional acrylate compound, a monofunctional methacrylate compound, a bifunctional acrylate compound, and a bifunctional methacrylate compound, and
a total content of the monofunctional acrylate compound, the monofunctional methacrylate compound, the bifunctional acrylate compound, and the bifunctional methacrylate compound with respect to a total solid content of the composition is 50% by mass or more.

4. The method for manufacturing a transfer sheet according to claim 1,
wherein a weight-average molecular weight of the acrylate resin and the methacrylate resin in the image layer is 200,000 or more.

5. The method for manufacturing a transfer sheet according to claim 1,
wherein the composition includes a compound represented by Formula (1), 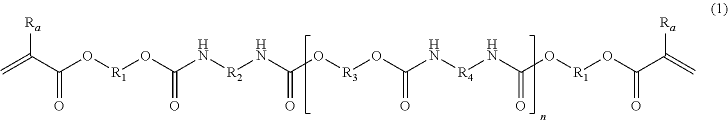
in the formula, Rₐ represents a hydrogen atom or a methyl group,
R₁ to R₄ each independently represent a divalent linking group,
n represents an integer of 1 to 10000, and
at least one of R₃ or R₄ represents a linear or branched alkylene group.

6. The method for manufacturing a transfer sheet according to claim 5,
wherein both of R₃ and R₄ each independently represent a linear or branched alkylene group.

7. The method for manufacturing a transfer sheet according to claim 1,
wherein the decorative layer is a metal layer or a cholesteric liquid crystal layer, and
the metal layer is a metal foil or a metal deposition layer.

8. The method for manufacturing a transfer sheet according to claim 1,
wherein in a plan view of the transfer sheet, the hot melt adhesive layer is disposed on only the image layer, and a ratio of an area of the hot melt adhesive layer to an area of the image layer is 60% to 100%.

9. A transfer sheet manufactured using the manufacturing method according to claim 1,
the transfer sheet comprising, in the following order:
a temporary support;
a decorative layer;
an image layer; and
a hot melt adhesive layer,
wherein the image layer includes one or more kinds selected from the group consisting of an acrylate resin and a methacrylate resin, and
an intensity ratio P₂ obtained from Expression (Y1) is 1.25 to 50.0,
$${P}_{2} = {Z}_{22} / {Z}_{21} , \qquad Expression ( Y 1 )$$
in Expression (Y1), P₂ represents the intensity ratio,
Z₂₁ represents a normalized carbon double bond peak intensity of a surface of the image layer on the decorative layer side obtained from Expression (Y2), and
Z₂₂ represents a normalized carbon double bond peak intensity of a surface of the image layer on the hot melt adhesive layer side obtained from Expression (Y3),
$${Z}_{21} = {Y}_{21} / {X}_{21} , \qquad Expression ( Y2 )$$
in Expression (Y2), X₂₁ represents a peak intensity derived from C═O of an ester group obtained by infrared absorption spectroscopy of the surface of the image layer on the decorative layer side,
Y₂₁ represents a peak intensity derived from a carbon double bond C═C obtained by the infrared absorption spectroscopy of the surface of the image layer on the decorative layer side, and
Z₂₁ represents the normalized carbon double bond peak intensity,
$${Z}_{22} = {Y}_{22} / {X}_{22} , \qquad Expression ( Y3 )$$
in Expression (Y3), X₂₂ represents a peak intensity derived from C═O of an ester group obtained by infrared absorption spectroscopy of the surface of the image layer on the hot melt adhesive layer side,
Y₂₂ represents a peak intensity derived from a carbon double bond C═C obtained by the infrared absorption spectroscopy of the surface of the image layer on the hot melt adhesive layer side, and
Z₂₂ represents the normalized carbon double bond peak intensity.

10. The transfer sheet according to claim 9,
wherein the image layer is a cured layer including one or more kinds selected from the group consisting of an acrylate compound and a methacrylate compound,
the composition includes one or more kinds selected from the group consisting of a monofunctional acrylate compound, a monofunctional methacrylate compound, a bifunctional acrylate compound, and a bifunctional methacrylate compound, and
a total content of the monofunctional acrylate compound, the monofunctional methacrylate compound, the bifunctional acrylate compound, and the bifunctional methacrylate compound with respect to a total solid content of the composition is 50% by mass or more.

11. The transfer sheet according to claim 9,
wherein a weight-average molecular weight of the acrylate resin and the methacrylate resin in the image layer is 200,000 or more.

12. The transfer sheet according to claim 9,
wherein the composition includes a compound represented by Formula (1), 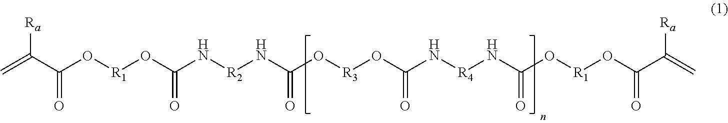
in the formula, Rₐ represents a hydrogen atom or a methyl group,
R₁ to R₄ each independently represent a divalent linking group,
n represents an integer of 1 to 10000, and
at least one of R₃ or R₄ represents a linear or branched alkylene group.

13. The transfer sheet according to claim 12,
wherein both of R₃ and R₄ each independently represent a linear or branched alkylene group.

14. The transfer sheet according to claim 9,
wherein the decorative layer is a metal layer or a cholesteric liquid crystal layer, and
the metal layer is a metal foil or a metal deposition layer.

15. The transfer sheet according to claim 9,
wherein in a plan view of the transfer sheet, the hot melt adhesive layer is disposed on only the image layer, and a ratio of an area of the hot melt adhesive layer to an area of the image layer is 60% to 100%.

16. The method for manufacturing a transfer sheet according to claim 2,
wherein the composition includes one or more kinds selected from the group consisting of a monofunctional acrylate compound, a monofunctional methacrylate compound, a bifunctional acrylate compound, and a bifunctional methacrylate compound, and
a total content of the monofunctional acrylate compound, the monofunctional methacrylate compound, the bifunctional acrylate compound, and the bifunctional methacrylate compound with respect to a total solid content of the composition is 50% by mass or more.

17. The method for manufacturing a transfer sheet according to claim 2,
wherein a weight-average molecular weight of the acrylate resin and the methacrylate resin in the image layer is 200,000 or more.

18. The method for manufacturing a transfer sheet according to claim 2,
wherein the composition includes a compound represented by Formula (1), 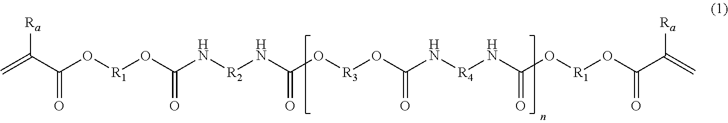
in the formula, Rₐ represents a hydrogen atom or a methyl group,
R₁ to R₄ each independently represent a divalent linking group,
n represents an integer of 1 to 10000, and
at least one of R₃ or R₄ represents a linear or branched alkylene group.

19. The method for manufacturing a transfer sheet according to claim 18,
wherein both of R₃ and R₄ each independently represent a linear or branched alkylene group.

20. The method for manufacturing a transfer sheet according to claim 2,
wherein the decorative layer is a metal layer or a cholesteric liquid crystal layer, and
the metal layer is a metal foil or a metal deposition layer.
